(19) United States
(12) Patent Application Publication
(10) Pub. No.: US 2026/0195331 A1
(43) Pub. Date: Jul. 9, 2026

(54) EFFICIENT RETRIEVAL AND RANKING WITH LARGE LANGUAGE MODELS

(71) Applicant: Microsoft Technology Licensing, LLC, Redmond, WA (US)

(72) Inventors: Birjodh Singh Tiwana, Dublin, CA (US); Vinay Yajamana Satyanarayana, Mountain View, CA (US); Akhilesh Gupta, Mountain View, CA (US); Mohammad H. Firooz, Los Altos, CA (US); Manas Haribhai Somaiya, Sunnyvale, CA (US); Luke E. Simon, Emerald Hills, CA (US); Andrea Olgiati, Gilroy, CA (US); Hristo I. Danchev, Wake Forest, NC (US); Fedor V. Borisyuk, Mountain View, CA (US); Qingquan Song, Sunnyvale, CA (US); Yun Dai, Santa Clara, CA (US); Kayhan Behdin, Sunnyvale, CA (US); Ataollah Fatahi Baarzi, San Jose, CA (US); Aman Gupta, San Jose, CA (US); Zhipeng Wang, San Carlos, CA (US); Borja Ocejo Elizondo, Chicago, IL (US); Jihye Choi, Sunnyvale, CA (US); Andrei Akterskii, San Francisco, CA (US); Zihan Xiong, San Jose, CA (US); Zhanglong Liu, Fremont, CA (US); Sen Zhou, Cupertino, CA (US); Zhoutao Pei, South San Francisco, CA (US); Hejian Sang, San Jose, CA (US)

(21) Appl. No.: 19/251,682

(22) Filed: Jun. 26, 2025

Related U.S. Application Data
(60) Provisional application No. 63/742,429, filed on Jan. 7, 2025.
(60) Provisional application No. 63/784,873, filed on Apr. 7, 2025.

(51) Int. Cl. G06F 16/2457; G06N 3/0455

(52) U.S. Cl. CPC G06F 16/24578; G06N 3/0455

(57) ABSTRACT

An example may, at a first device, input an entity embedding for an entity and an item embedding for a plurality of items to a scoring function. The entity embedding and the item embedding are pre-computed using a first language model. At the first device, a retrieval score for the entity and a first item of the plurality of items is computed. The retrieval score is used to identify an item subset of the plurality of items. A ranking prompt is input to a second language model. The second language model and the first language model have a common parameter value. The second language model generates a ranking score for the entity and a second item in response to the ranking prompt. An online system uses the ranking score to include or exclude the second item from a presentation of digital content to the entity via a device.

### CROSS-REFERENCE TO RELATED APPLICATIONS

The present application claims the benefit of and priority to U.S. Provisional Patent Application Ser. No. 63/742,429 filed Jan. 7, 2025, and U.S. Provisional Patent Application Ser. No. 63/784,873 filed Apr. 7, 2025, each of which is incorporated by reference herein.

### TECHNICAL FIELD

Technical fields to which this disclosure relates include digital content distribution systems. Other technical fields to which this disclosure relates include applications of machine learning models to embedding generation for digital content distribution systems.

### COPYRIGHT NOTICE

This patent document, including the accompanying drawings, contains material that is subject to copyright protection. The copyright owner has no objection to the facsimile reproduction of this patent document, as it appears in the publicly accessible records of the United States Patent and Trademark Office, consistent with the fair use principles of the United States copyright laws, but otherwise reserves all copyright rights whatsoever.

### BACKGROUND

A content distribution system is a computer system that routes or distributes digital content items to various endpoints, such as devices on a network, in accordance with one or more criteria. Machine learning is a category of artificial intelligence. In machine learning, a model is created using a machine learning algorithm. A machine learning algorithm is a mathematical and/or logical expression of a relationship between inputs and outputs of the machine learning model. During a training process, training data is input to the model and the values of coefficients and/or parameters of the model are adjusted iteratively until the output of the model satisfies applicable performance criteria relating to how closely the model's predicted output matches the expected result. Machine learning models may be used to perform retrieval and ranking functions of a content distribution system.

### BRIEF DESCRIPTION OF THE DRAWINGS

The disclosure will be understood more fully from the detailed description given below and from the accompanying drawings of various examples of the disclosure. The drawings are for explanation and understanding only and should not be taken to limit the disclosure to the specific examples shown.

FIG. 1 is a component-based flow diagram including an example of an online system for retrieval and ranking.

FIG. 2 is a component-based flow diagram including an example of an online system for retrieval and ranking.

FIG. 3A is a component-based flow diagram illustrating an example of an architecture and operation of a cross encoder machine learning model trained to generate and output ranking scores.

FIG. 3B is a component-based flow diagram illustrating an example of an architecture and operation of a dual encoder machine learning model trained to generate retrieval scores.

FIG. 4 is a component-based flow diagram illustrating an example of an architecture and operation of a dual encoder machine learning model trained to generate retrieval scores.

FIG. 5 is a block diagram of an example of a two stage distillation process for fine-tuning a dual encoder retrieval model from a cross encoder ranking model.

FIG. 6 is a schematic flow diagram of an example of a two stage distillation process to fine-tune a dual encoder retrieval model from a cross encoder ranking model.

FIG. 7 is a flow diagram of an example method in accordance with some examples of the present disclosure.

FIG. 8 is a block diagram of a computing system that includes retrieval and ranking in accordance with some examples of the present disclosure.

FIG. 9A, FIG. 9B, and FIG. 9C are block diagrams of examples of machine learning models portions of which are usable by and/or included in a retrieval and ranking system in accordance with some examples of the present disclosure.

FIG. 10 is a block diagram of an example computer system including components of a retrieval and ranking system in accordance with some examples of the present disclosure.

### DETAILED DESCRIPTION

An online software application system may connect over a billion users to digital content and other users across hundreds of different geographic regions. Aspects of such an online network may be designed to foster a vibrant ecosystem of information exchange, enabling users to discover valuable content, learn new skills, and explore diverse products, services, educational opportunities, and/or career options.

In many online systems, a content delivery mechanism such as a feed serves as a primary entry point to application ecosystem. A goal of these platforms is to personalize the feed so that the content delivered through the feed is as relevant and valuable as possible to the user presented with the feed. In some platforms, a user may be presented with tens of thousands of content items over a relatively short period of time such as a year or less. The number of content items circulating on these platforms continues to grow year over year.

Due to these and/or other characteristics of online platforms, content recommendation systems may use a two-stage process to determine whether and how to route items to users: stage one is retrieval and stage two is ranking. In an example, given a content inventory that includes billions of potentially recommended digital content items, the retrieval stage selects hundreds to thousands of those items for ordering by the ranking stage. In large-scale recommendation systems, the retrieval stage is responsible for efficiently fetching relevant items for input to a ranking model. The ranking model orders the items fetched by the retrieval model according to one or more ranking criteria. In online recommendation platforms such as social network-based applications, where the number of items potentially recommended to a user can be in the millions, a technical challenge is providing recommended items to users at scale with high recall while also maintaining acceptable latency.

This and other technical challenges are addressed by aspects of retrieval and ranking systems described herein. Examples provide optimizations that facilitate the deployment of large language models in a high throughput, low latency retrieval and ranking pipeline. Examples provide a model architecture and training approach that improve the alignment of the retrieval model with the ranking model such that retrieval scores output by the retrieval model may closely approximate ranking scores output by the ranking model, thereby enhancing recall and reducing the need for realignments.

Examples provide an efficient and lightweight retrieval stage as described herein. Examples of the described retrieval stage are capable of quickly identifying the most relevant items to maximize the effectiveness of the ranking model. In some examples, at the retrieval stage, embedding-based retrieval (EBR) is used for item selection, optimizing for recall. However, for optimal performance, items retrieved by the retrieval stage should be well-aligned with the ranking model's objectives so that items that are ranked highly by the retrieval stage are also ordered near the top of the ranked list of items produced by the ranking model, and items that are ranked low by the retrieval stage are not placed near the top of the list by the ranking model.

Described herein are approaches that apply language models, such as large language models (LLMs), e.g., BERT (Bidirectional Encoder Representations from Transformers) or other forms of Transformer-based models, to the retrieval stage. Fine-tuning these models as described herein has been shown to effectively capture entity interests (e.g., user preferences as to topics of content) and the semantic nuances of content items in the final embedding layer. In some examples, a Small Language Model (SML) is implemented in the online serving path, which offers improved latency and throughput while maintaining quality (e.g., high recall) comparable to larger models. In some examples, publicly available engagement data is leveraged at the retrieval stage to provide LLM-derived embeddings that capture count-based features that are useful to the ranking model. An online infrastructure capable of being used to score and rank items for entities at scale is described.

Illustrative, non-limiting examples of items include digital content items such as articles, job postings, entity profiles, recordings, videos, images, social media posts, comments, messages, multimodal content items, and/or other forms of digital content. Illustrative, non-limiting examples of entities include digital representations of users and organizations, devices, and digital agents. An entity may be represented in an online system by, e.g., a respective identifier, profile, or set of attributes.

The disclosure will be understood more fully from the detailed description given below, which references the accompanying drawings. The detailed description of the drawings is for explanation and understanding, and should not be taken to limit the disclosure to the specific examples described. In some examples, components with the same name but different reference numbers in different figures have the same or similar functionality such that a description of one of those components with respect to one figure is applicable to other components with the same name in other drawings. Also, in the drawings and the following description, components shown and described in connection with some examples are capable of being used with or incorporated into other examples. In some examples, a component illustrated in a certain drawing is not limited to use in connection with the example to which the drawing pertains, but is usable with or incorporated into other examples, including examples shown in other drawings.

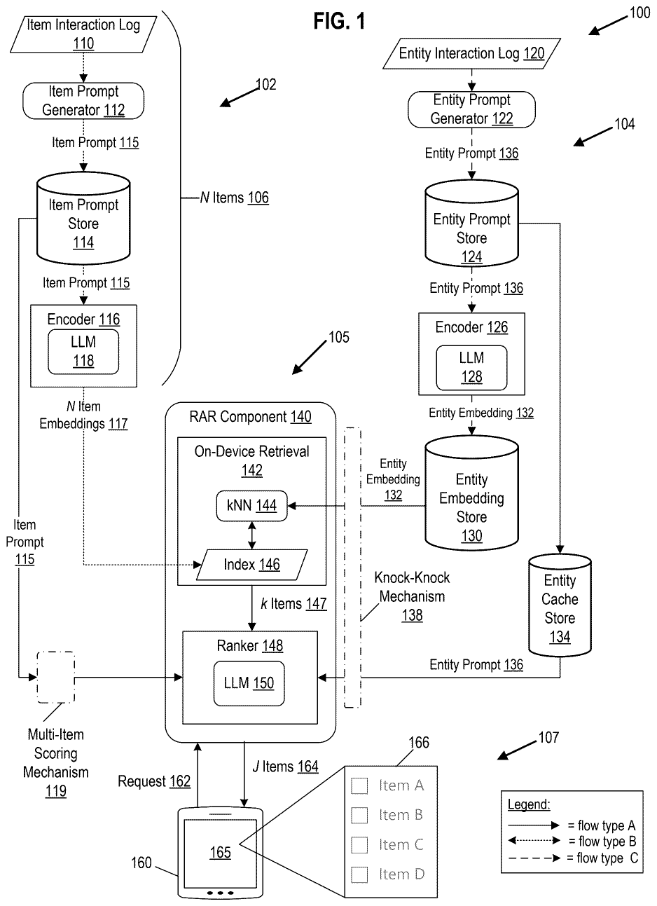

FIG. 1 is a component-based flow diagram including an example of an online system for retrieval and ranking.

FIG. 1 illustrates a method 100. The method 100 includes operations performed by a retrieval and ranking computing system that uses a retrieval and ranking (RAR) component 140 to retrieve and rank digital content items for an online presentation environment such as a feed or another type of recommendation engine, e.g., a job recommendation engine or connection recommendation engine. Portions of the method 100 include communications between the retrieval and ranking component 140 and/or other components of the retrieval and ranking computing system.

In the example of FIG. 1, some or all portions of the RAR component 140 are executed directly on a special processor device such as a graphics processing unit (GPU) while other portions may be executed on one or more other devices. The described approaches include mechanisms such as multi-item scoring mechanism 119 and knock-knock mechanism 138, which are adapted to the GPU hardware as they enable pre-computed embeddings and KV caches to be compactly stored on the GPU and/or enable portions of the retrieval and ranking processes performed by on-device retrieval component 142 and ranker component 148 to proceed in parallel.

In FIG. 1, portions of the method 100 are represented by arrows connecting components of the illustrated computing system. As shown by the legend, in the arrows, different arrow patterns are used to represent potentially different flow types potentially occurring in different time intervals, at different scheduling frequencies, and/or on different portions of the computing system, from one or more of the other flows. In some examples, flow A represented by solid arrows is an online flow type, flow B represented by dotted arrows is a first nearline flow type, and flow C represented by dashed arrows is a second nearline flow type.

Flow type B and flow type C are identified in the drawing as different flow types because they may occur concurrently or at different time intervals or at different frequencies, depending upon the requirements of a particular application. For instance, while flow type B and flow type C are both nearline flows, flow type B may be executed more frequently than flow type C if the item interaction log 110 is updated (e.g., new interactions are added to the log) more frequently than the entity interaction log 120. If entity interaction log 120 is updated more frequently than the item interaction log 110, then flow type C may be executed more frequently than flow type B.

Online flows include flows that occur more quickly, in terms of computational time or response time to user requests, and/or more frequently than nearline flows. Nearline flows include flows that occur less quickly, in terms of computational time or response time to user requests, and/or less frequently than online flows, but more quickly and/or more frequently than offline flows, in some examples. Components shown in FIG. 1 with a dot-dash outline are optional optimizations that may be implemented individually or in combination in various examples.

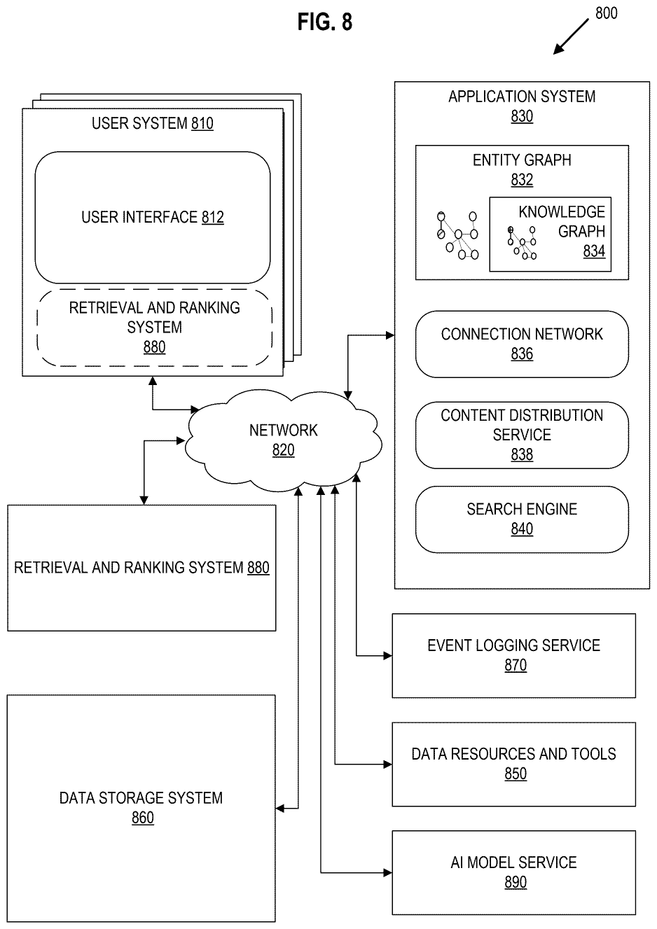

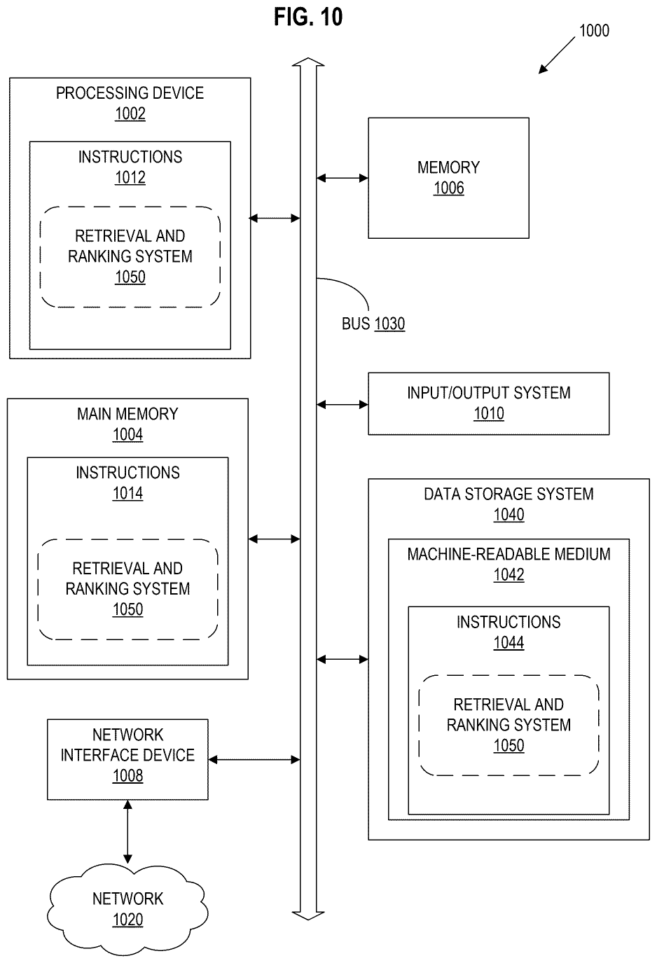

Other components of the retrieval and ranking computing system of FIG. 1 include an item-side flow 102, an entity-side flow 104, a retrieval and ranking flow 105, and a presentation-side flow 107. Examples of computing systems capable of including components shown in FIG. 1 are described with reference to, e.g., FIG. 8 and FIG. 10.

The item-side flow 102 converts an item interaction log 110 into N item embeddings 117, and uses the N item embeddings to identify N items 106 to retrieval and ranking component 140, where N is a positive integer whose value is likely less than but potentially equal to the total number of items in the entire corpus of all items circulating in an online application software system. For instance, the value of N may be determined via an initial filtering process performed by executing a query or attribute-based matching on a larger item corpus.

In the flow type B portion of the item-side flow 102, N item embeddings 117 are generated, respectively, for the corresponding N items 106 (e.g., one item embedding is generated for each item). In the flow type A portion of the item-side flow 102, the N items 106 are identified to the retrieval and ranking component 140 via the respective N item embeddings 117, in response to a request 162 received via the device 160 and the online application software system.

The entity-side flow 104 identifies an entity, e.g., a user of a device 160 operating the online application software system, to retrieval and ranking component 140. In the flow type C portion of the entity-side flow 104, an entity interaction log 120 for the entity is converted to an entity embedding 132. In the flow type A portion of the entity-side flow 104, the entity is identified to the retrieval and ranking component 140 via the entity embedding 132, in response to the request 162 received via the device 160 and the online application software system.

The retrieval and ranking flow 105 evaluates the N item embeddings 117 in comparison to the entity embedding 132 in two stages: a retrieval stage and a ranking stage. In the retrieval stage, an on-device retrieval component 142 generates retrieval scores for the N items 106 using the item embeddings 117 and selects the top k items 147 based on the retrieval scores. The value of k is less than the value of N and greater than the value of J. The top k items are those items of the N items that have the k highest retrieval scores. In the ranking stage, a ranker component 148 generates ranking scores for the k items 147 and orders the k items 147 based on the ranking score. The J items 164 are those items of the k items 147 that have the highest ranking scores.

The presentation-side flow 107 presents J items 164, which have been retrieved and ranked by the retrieval and ranking component 140, to the entity via the device 160. The value of J is less than the value of N. In the example of FIG. 1, the J items 164 are arranged for presentation to the entity via a front end of the online application software system 165, at the device 160, e.g., as a ranked or ordered list of items 166. In the list of items 166, the first item in the list (e.g., Item A) has the highest probability of being engaged with by the entity, the second item in the list (e.g., Item B) has the next highest probability of being engaged with by the entity via the device 160, and so on, such that the J items 164 are presented in descending order of engagement probability with respect to the entity.

Each of the item-side flow 102, entity-side flow 104, and retrieval and ranking flow 105 includes a large language model (LLM), e.g., LLM 118, LLM 128, and LLM 150). References to a large language model or LLM are made for ease of discussion but the referenced models are not required to be “large” (e.g., tens or hundreds of billions of parameters or more). Thus, any model referred to herein as a large language model or LLM is capable of being implemented as a smaller language model (e.g., less than ten billion parameters) in accordance with the requirements of a particular system.

In some examples, each of the LLMs 118, 128, 150 is implemented as a decoder-only transformer-based language model (as opposed to an encoder-decoder transformer model or an encoder-only transformer model). A decoder-only LLM is a variant of a transformer architecture that retains only the decoder component (e.g., the encoder is omitted or deactivated).

The decoder-only LLM used in some examples of the LLMs 118, 128, 150 includes a causal decoder architecture. The causal decoder architecture incorporates a unidirectional (e.g., forward-only) attention mask. This allows each input token to attend only to tokens previously seen and processed (e.g., tokens that have earlier positions in the input sequence than the current token being processed). This is in contrast to non-causal decoder architectures, which enable bidirectional attention over some tokens.

In some examples, the decoder-only transformer architecture enables better alignment between ranking and retrieval tasks than encoder-decoder architectures or encoder-only architectures. Also or alternatively, decoder-only architectures can be tuned with few shot or zero shot training because the decoder is capable of generalizing to different tasks with only a small amount of training.

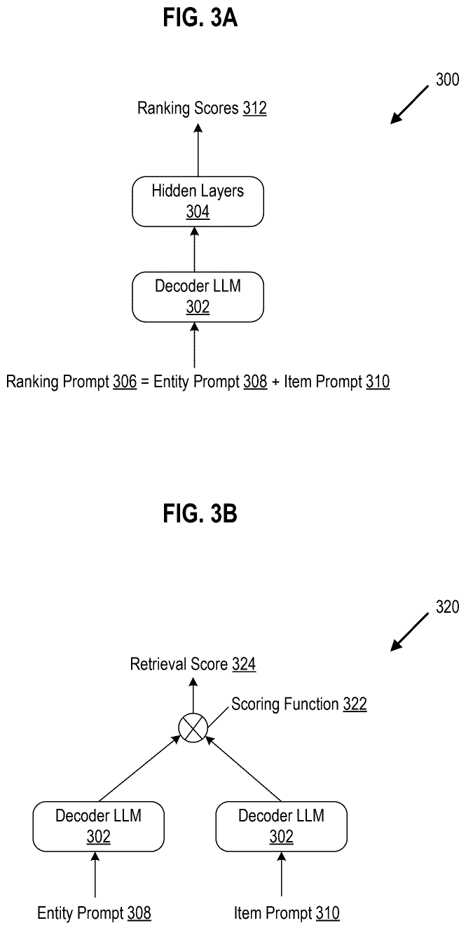

The decoder-only LLMs 118, 128 are used as encoders in a dual encoder architecture such as shown in FIG. 3A, described below, in which parameters are shared between the LLM 118 and the LLM 128. The decoder-only LLM 150 is used as a cross encoder such as shown in FIG. 3B, described below.

The model architecture and training approaches used to create the LLMs 118, 128, 150, described in more detail below, facilitate the performance of the entire retrieval and ranking pipeline in nearline and online time. This improves the freshness of the embeddings used to perform the retrieval and ranking stages. In turn, this greatly improves the performance of the retrieval and ranking system over other systems that are required to perform portions of the retrieval and ranking pipeline offline.

In more detail, the item-side flow 102 includes an item interaction log 110, an item prompt generator 112, an item prompt store 114, an encoder 116 (including the LLM 118), and a multi-item scoring mechanism 119.

The item interaction log 110 includes, for each item of the N items 106, an item identifier, item content, and a textual history of interactions with the item by entities using the online application software system (e.g., entity 11 interacted with item A at timestamp 1, entity 33 interacted with item A at timestamp 2, etc.). The interactions included in the item interaction log 110 include interactions with items that involve the entity associated with the request 162 and/or other entities.

The item prompt generator 112 extracts information for each of the N items 106 from the item interaction log 110 and uses the extracted information to formulate item prompt 115. Item prompt 115 includes for each of the N items 106, the item identifier, a selected portion of the item content, and an item-side count-based feature. The resulting item prompt 115 contains an item-specific sub-prompt for each of the N items 106 (e.g., the N item-specific sub-prompts are joined or concatenated to form a single text string in which a special token is used to identify the starting and ending tokens of each item-specific sub-prompt). An example format for the item prompt 115 is [item1_sub-prompt, . . . , itemN_sub-prompt], where each item_sub-prompt includes {item_ID, selected_portion_of item_content, item_interaction_history, [sp]}, and [sp] signifies a special token.

The item prompt generator 112 determines the selected portion of the item content for a given item in the corresponding item-specific sub-prompt based on the requirements of a particular application. The selected portion of the item content included in the item-specific sub-prompt is less than the entire item content, in some examples. For instance, the selected portion of the item content included in the item-specific sub-prompt for a given item includes, e.g., only the first two sentences of the item, or only the first x characters or tokens of the item, where x is a positive integer whose value is less than 1000, or less than 500, or less than 300, or less than 100 characters or tokens. Portions of the item content that are not part of the selected portion are excluded from the item-specific sub-prompt for that item.

The item prompt generator 112 computes the item-side count-based feature for a given item based on the item interaction history associated with that item. Examples of count-based features include engagement metrics and item popularity metrics, such as a count of the total number of positive interactions with the item in a given time interval.

The item prompt generator 112 incorporates the sequence of item-specific sub-prompts into a pre-defined prompt template, in some examples. The pre-defined prompt template specifies the format for the item prompt 115, such as the special tokens, and/or includes additional information or instructions to guide or constrain the processing of the item prompt 115 by the LLM 150.

The item prompt store 114 includes a data store, e.g., a nearline data store. The item prompt store 114 stores the item prompt 115 produced by item prompt generator 112.

The encoder 116 includes the LLM 118. The LLM 118 generates and outputs the N item embeddings 117 in response to the item prompt 115. The LLM 118 and the LLM 128 collectively form a dual encoder retrieval model, which is used for the retrieval stage of the retrieval and ranking process. At the dual encoder retrieval model, the item prompt 115 is input to the LLM 118 and the entity prompt 136, described below, is input to the LLM 128.

At the ranking stage of the retrieval and ranking process, the item prompt 115 and the entity prompt 136 are combined at the ranker component 148 to form a ranking prompt. The multi-item scoring mechanism 119 addresses the issue of a large number of items being included in the ranking prompt for the ranker component 148, which the LLM 150 is being instructed to generate a score (e.g., the ranking model, LLM 150, is to generate a ranking score for each item in the ranking prompt based on a comparison of the information contained in the item prompt for that item to the entity data included in the entity prompt for the entity). Without muti-item scoring mechanism 119, the LLM 150 generates a ranking score for each item independently. With multi-item scoring, the item data in item prompt portion of the ranking prompt is reformulated so that the LLM 150 can score the items in parallel (using, e.g., a high capacity processing device such as one or more graphics processing units or GPUs) instead of sequentially. To reformulate the item data, the multi-scoring mechanism 119 uses principles of matrix superimposing. Via matrix superimposition principles, the items are superimposed on each other so that they can each be scored against the entity concurrently, e.g., all at the same time, by the LLM 150.

The entity-side flow 104 includes an entity interaction log 120, an entity prompt generator 122, an entity prompt store 124, an encoder 126 (including the LLM 128), an entity embedding store 130, an entity cache store 134, and a knock-knock mechanism 138.

The entity interaction log 120, includes, for a specific entity of the online application software system (e.g., the entity interacting with the application via the device 160), an entity identifier, entity profile data, and a textual history of interactions of that entity with items circulating in the online application software system (e.g., entity 11 interacted with item A at timestamp 1, entity 11 interacted with item B at timestamp 2, etc.). The interactions included in the entity interaction log 110 include interactions of the entity with items that have been presented to the entity via in the entity's feed, notification center, messaging application, search results, recommendations portal, and/or other content delivery mechanisms used by the online application software system.

The entity prompt generator 122 extracts information for the entity from the entity interaction log 120 and uses the extracted information to formulate entity prompt 136. Entity prompt 136 includes the entity identifier, the entity profile data, and an entity-side count-based feature.

The entity prompt generator 122 computes the entity-side count-based feature for a given entity based on the entity interaction history associated with that entity. Examples of count-based features include engagement metrics and popularity metrics, such as a count of the total number of positive interactions of the entity with items presented in the entity's feed in a given time interval.

The entity prompt generator 122 incorporates the entity identifier, entity profile data, and entity-side count-based feature into a pre-defined prompt template, in some examples. The pre-defined prompt template specifies the format for the entity prompt 122, including additional information or instructions to guide or constrain the processing of the entity prompt 136 by the LLM 150.

In some examples, the entity-side prompt template used by the entity prompt generator 122 to formulate the entity prompt 136 includes natural language instructions that when processed by the LLM 150, cause the LLM 150 to compute a ranking score for each entity-item pair. The instructions included in the entity prompt 136 provide the LLM 150 with information about how to compute the ranking score, e.g., as a probability of engagement between the entity and the item in a given entity-item pair. Thus, when the entity prompt 136 is combined with the item prompt 115 at the ranker component 148 to form a ranking prompt, the resulting ranking prompt includes the instructions needed to guide the LLM 150 in generating the ranking scores (e.g., for a given ranking prompt, an instruction to compute one ranking score for each comparison of an item contained in the item prompt 115 to the entity contained in the entity prompt 136, where the comparison involves computing a likelihood, e.g., a probability, of the entity engaging with the item). Examples of engagements between an entity and an item include positive interactions via the online application software system, such as views, likes, clicks, comments, shares, follows, etc.

The entity prompt store 124 is a data store, e.g., a nearline data store. Entity prompt store 124 stores the entity prompt 136 produced by entity prompt generator 122. Entity prompt 136 is retrieved from entity prompt store 124 and loaded into entity cache store 134, in some examples. The entity cache store 134 is a key value (KV) cache, in some examples. Use of the entity cache store 134 to store the entity prompt 136 optimizes the inference process of the LLM 150 at the ranking stage because it preserves the entity prompt 136 for reuse with each item-specific sub-prompt of the item prompt 115, thereby facilitating the computation of the entity-item ranking scores at the ranking stage.

The encoder 126 includes the LLM 128. The LLM 128 generates and outputs an entity embedding 132 in response to the entity prompt 136. The LLM 128 and the LLM 118 collectively form a dual encoder retrieval model, which generates embeddings that are used for the retrieval stage of the retrieval and ranking process. At the dual encoder retrieval model, the entity prompt is input to the LLM 128 and the item prompt 115, described above, is input to the LLM 118. The LLM 118 generates the N item embeddings 117 in response to the item prompt 115 and the LLM 128 generates the entity embedding 132 in response to the entity prompt 136.

The entity embedding store 130 is a data store, e.g., a nearline data store. Entity embedding store 130 stores the entity embedding 132 produced by LLM 128 of encoder 126. Including entity embedding store 130 in the pipeline enables the entity embedding 132 to be pre-computed and stored for efficient access by the RAR component 140, e.g., in response to a request 162.

At the ranking stage of the retrieval and ranking process, the entity prompt 136 is combined with the item prompt 115 at the ranker component 148 to form the ranking prompt.

The knock-knock mechanism 138 reduces the computational costs of using the LLM 150 at the ranker component 148. An LLM can have two different types of computational cost: prefill cost and generation cost. The prefill cost is the computational cost associated with filling an LLM prompt with the information the LLM is to use to process an instruction. For instance, an LLM prompt for ranking could include entity data (e.g., query received from a user, attributes from the user's online profile, aspects of the user's interaction history, etc.), item data (e.g., the contents of a digital content item) for each item to be ranked for the entity (e.g., the top k items retrieved by the retrieval model), and a ranking instruction that instructs the LLM to rank the items based on matching criteria and the entity data. The prefilling cost relates to the computational time needed to obtain all of the information needed to be included in the LLM prompt. The generation cost is the computational cost for the LLM to generate output in accordance with the instruction included in the prompt and the size of the input. Each or either of these costs can be represented in units of tokens. In some examples, the prefilling cost is much greater than the generation cost, due, for example, to the number of prospective items to be matched with the entity.

With the knock-knock mechanism 138, the LLM prompt for the ranking model (e.g., ranker component 148) is divided into two calls to the LLM 150. When the retrieval model (e.g., on-device retrieval component 142) is called to retrieve the top k items, another, partial, call is made to the ranking model at the same time. This partial, entity-side call to the ranking model includes only the entity side of the ranking prompt such that the retrieval model can be working on the item side retrieval in parallel. In response to this partial, entity-side call, the ranking model starts constructing a KV cache so that when the retrieval model has determined the top k items, the item data for those items can be added to the previously partially filled ranking prompt. Then, the completed ranking prompt including both the entity data (e.g., entity prompt 136) and the item data (e.g., item prompt 115 for only the top k items 147) is provided to the ranking model in a second or subsequent call to the LLM 150. The knock-knock mechanism 138 avoids the prefill cost because the KV cache is pre-constructed via the first, partial, entity-side call.

The retrieval and ranking flow 105 includes on-device retrieval component 142 and ranker component 148. The on-device retrieval component 142 performs an embedding-based retrieval (EBR) process using the pre-computed entity embedding 132 and the pre-computed N item embeddings 117. On-device indicates that the EBR-based retrieval process is performed directly on-device, where the device on which the process is performed is a processing device or electronic circuit that is capable of efficiently parallel processing data-intensive and computationally demanding tasks, such as one or more graphics processing units (GPUs).

On-device retrieval component 142 includes a k-nearest neighbors (kNN) component 144 and an index 146. The N item embeddings 117 are loaded into the index 146. The kNN component 144 uses the index 146 of N item embeddings 117 and the entity embedding 132 to determine the top k items 147. The kNN component 144 uses, e.g., a nearest-neighbor algorithm to identify the k items 1447 that are the “nearest neighbors” to the entity embedding 132 using a distance metric such as cosine similarity, which determined by, e.g., computing a dot product for each of the N item embeddings 117 crossed with the entity embedding 132.

Ranker component 148 includes LLM 150. As described above, the LLM 150 includes a cross encoder ranking model. In the retrieval and ranking flow 105, the ranker component 148 generates ranking scores using a combined ranking prompt, which is a combination of the entity prompt 136 and the item prompt 115 for just the k items 147 identified by the on-device retrieval component 142. For instance, portions of the item prompt 115 that pertain to the items in the intersection of the set of N items 106 and the set of k items 147 are included in the combined ranking prompt while other portions that pertain to items not included in the intersection of those two sets are excluded from the combined ranking prompt. Ranker component 148 identifies the J items 164 based on the ranking scores produced by LLM 150.

When an entity request 162 is received (e.g., a request to load content into a user's feed), the dual encoder retrieval model is called to retrieve the top k items based on the entity request 162 using the pre-computed embeddings. The cross encoder ranker model re-ranks the top k items and selects a subset of the reranked items, J items 164, to be provided to the user's device, e.g., device 160. In either or both of the retrieval and ranking stages, the retrieval and ranking component 140 causes one or more items to be included in or excluded from the subsequent stage, which in turn causes one or more items to be included in or excluded from a presentation of items (e.g., list of items 166) at a device (e.g., device 160).

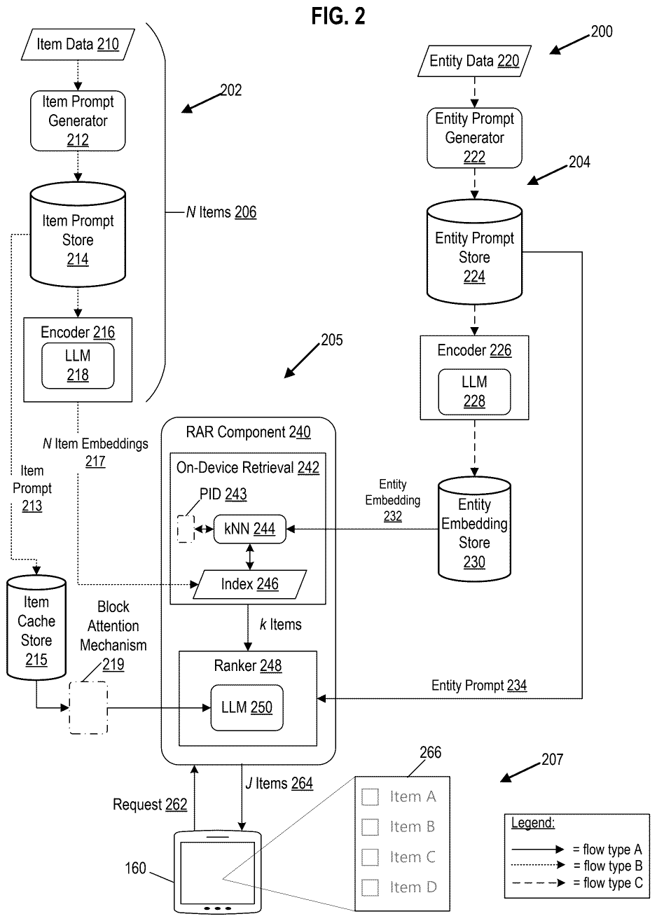

In the example of FIG. 1, the knock-knock mechanism 138 is used to improve efficiency in the entity-side flow 104 and the multi-item scoring mechanism 119 is used to improve efficiency in the item-side flow 102. The example of FIG. 1 shows use of a cache store (e.g., a KV cache) in the entity-side flow 104. In the example of FIG. 2, described below, a cache store is implemented in the item-side flow rather than in the entity side flow. While not specifically shown in FIG. 2, a knock-knock mechanism similar to knock-knock mechanism 138 can be implemented in the item-side flow rather than the entity-side flow, e.g., in place of the block attention mechanism 219. Alternatively or in addition, in the example of FIG. 2, a multi-item scoring mechanism similar to multi-item scoring mechanism 119 can be implemented in the entity-side flow rather than the item-side flow. Similarly, in the example of FIG. 1, a block attention mechanism similar to block attention mechanism 219, described below, can be implemented in the item-side flow, e.g., in place of multi-item scoring mechanism 119.

The examples shown in FIG. 1 and the accompanying description are provided for illustration purposes. This disclosure is not limited to the described examples.

FIG. 2 is a component-based flow diagram including an example of an online system for retrieval and ranking.

FIG. 2 illustrates a method 200. The method 200 includes operations performed by a retrieval and ranking computing system that uses a retrieval and ranking (RAR) component 240 to retrieve and rank digital content items for an online presentation environment such as a feed or another type of recommendation engine. Portions of the method 200 include communications between the retrieval and ranking component 240 and/or other components of the retrieval and ranking computing system.

In FIG. 2, portions of the method 200 are represented by arrows connecting components of the illustrated computing system. As shown by the legend, in the arrows, different arrow patterns are used to represent potentially different flow types potentially occurring in different time intervals, at different scheduling frequencies, and/or on different portions of the computing system, from one or more of the other flows. In some examples, flow A represented by solid arrows is an online flow type, flow B represented by dotted arrows is a first nearline flow type, and flow C represented by dashed arrows is a second nearline flow type.

FIG. 2 illustrates a variation of the pipeline shown in FIG. 1 and described above. Thus, portions of the description of FIG. 1 may be applicable to flows and components shown in FIG. 2 having similar names or reference numbers as flows and components shown in FIG. 1. Similarly, portions of the description of FIG. 2 may be applicable to flows and components shown in FIG. 1 having similar names or reference numbers as flows and components shown in FIG. 2.

In the example of FIG. 2, the LLMs 218, 228 are co-trained for both retrieval (e.g., EBR) and ranking using parameter tying. Partial inference is used to pre-compute the N item embeddings 217 that are used by both the on-device retrieval component 242 and the ranker component 248. A block attention mechanism 219 is used in some examples to improve the efficiency of these computations.

FIG. 2 includes an item-side flow 202, an entity-side flow 204, a retrieval and ranking flow 205, and a presentation-side flow 207. These flows are similar to the corresponding flows described with reference to FIG. 1, with differences noted below.

In the online portion of the retrieval and ranking flow 205, a request 262 is received. In response to the request 262, the N item embeddings 217 and the entity embedding 232 are retrieved and provided to on-device retrieval component 242 to perform EBR. At the ranker component 248, partial inference is performed on the N items 206 and the results are stored in the item cache store 215 (e.g., a KV cache) using block attention mechanism 219. The N items 206 are filtered down to the top k items using the EBR scores. The item cache store 215 is then used at the ranker component 248 to generate the ranking scores for the k items.

In the example of FIG. 2, some or all portions of the RAR component 240 are executed directly on a special processor device such as a graphics processing unit (GPU) while other portions may be executed on one or more other devices. The described approaches are adapted to the GPU hardware as they enable pre-computed embeddings and KV caches to be compactly stored on the GPU, where the KV caches can be concatenated together with very low latency. At the GPU, the block attention mechanism 219 allows for individual KV caches to be concatenated together. Since no model inference has to be done (due to the pre-computing of partial inferences), the concatenation can be almost an instantaneous operation supported at the hardware level in the GPU.

The on-device retrieval component 242 is adapted to the GPU hardware by having the partial inference pre-computed (e.g., N item embeddings) so that only the dot product is computed on the GPU (e.g., at kNN 244) at the time a response to the request 262 is needed.

Another adaptation to the GPU hardware is provided by the PID component 243, in some examples. Inclusion of the PID component 243 removes the need to provision the GPU for the amount of capacity that would be required for the worst case scenario (e.g., extreme spikes in network traffic). With the PID component 243, the GPU only needs to be provisioned for the most typical scenario (e.g., typical volume of network traffic) rather than for the worst case scenario.

FIG. 2 includes an item-side flow 202, an entity-side flow 204, a retrieval and ranking flow 205, and a presentation-side flow 207. These flows are similar to the corresponding flows described with reference to FIG. 1, with differences noted below.

In FIG. 2, the respective inputs to the item-side flow 202 and the entity-side flow 204 (e.g., item data 210 and entity data 220, respectively) do not specifically refer to interaction data. This is to indicate that in some examples, interaction data may be omitted from item data 210 and/or entity data 220, such that the inputs to LLMs 218, 228, 250 do not include count-based engagement metrics such as popularity metrics. In those examples, retrieval and ranking is based primarily on semantic similarity, e.g., without taking interaction history into account.

The item-side flow 202 includes an item cache store 215 and a block attention mechanism 219. The item cache store 215 is a key value (KV) cache, in some examples. Use of the item cache store 215 optimizes the inference process of the LLM 250 at the ranking stage because it preserves the item prompt 213 for reuse with each entity, thereby facilitating the computation of the entity-item ranking scores at the ranking stage.

The block attention mechanism 219 improves the scalability of the ranking stage at the ranker component 248. The block attention mechanism 219 chunks the KV cache (e.g., item cache store 215) into blocks to avoid the full quadratic increase in memory usage and compute that are often associated with a regular attention mechanism.

The entity-side flow 204 of FIG. 2 does not include a knock-knock mechanism or an entity cache store as described with reference to FIG. 1. However, other variations of the entity-side flow 204 may include one or more entity-side optimizations.

The retrieval and ranking flow 205 includes a PID component 243. The PID component 243 uses a quality factor to continuously adjust the value of k, i.e., the number of items provided to the ranker component 248. The PID component 243 adjusts the value of k to, for instance, maintain availability of the retrieval and ranking system within applicable service level standards or thresholds. The PID component 243 enables the retrieval and ranking component 240 to automatically self-calibrate in response to changes in network traffic due to, e.g., a failover or traffic spike. For instance, if network traffic increases significantly in a short period of time, the PID component 243 reduces the value of k. The PID component 243 increases the value of k as the capacity of the system increases.

In some examples, FIG. 1 and/or FIG. 2 provide an architecture for scaling artificial intelligence services for various functionalities of an online system, including feed, video, and news, which may be referred to as a knowledge marketplace matching engine. In some examples, components of this architecture include 1) personalization, 2) implementing a marketplace auction, and 3) supporting business logic.

An example scenario is: a prompt is provided to an LLM (Large Language Model), e.g., LLM 250. The prompt contains an item portion and an entity (e.g., user) portion. The prompt also contains billions of items (e.g., documents or other content items). The prompt includes an instruction and an entity profile (e.g., a user profile). The prompt requests the LLM to provide a probability that the entity associated with the entity profile will like or interact with a specific content item if the content item is presented to the entity (e.g., in the user's feed).

In some examples, the LLM 250 at the ranker component 248 includes a turbo RAG (Retrieval-Augmented Generation) component that utilizes a non-generative LLM such as a cross encoder instead of a generative LLM. Cross encoders are designed to evaluate the relevance of a KV (Key-Value) pair (e.g., query and a document pair), whereas a generative LLM might generate a response based upon a broader pattern of training and EBR (Embedding-Based Retrieval) data (e.g., user data). The cross encoder used for LLM 250 at ranker component 248 focuses on ranking and retrieving most relevant documents rather than generating text which is more prone to AI hallucination and is computationally expensive for the LLM.

The cross encoder ranking model (e.g., LLM 250) uses a pre-computed embedding for both the entity-side data (e.g., queries or requests 262) and the item-side data (e.g., documents). The pre-computed embedding is stored as a KV pair cache (“KV cache”). In an LLM for RAG, the LLM generates a prediction using the user's input data (e.g., request 262) and the retrieved item data via (e.g., embedding) which is fed to the LLM to generate an output. Here, instead of using a generative LLM, the cross encoder is used, which relevantly ranks and retrieves the appropriate items (e.g., documents) in response to the request 262 (e.g., query). Pre-computing the entity and item embeddings and storing in KV cache enables quick look up in real time or near-real time, because only the computation on the KV cache and the query request needs to be performed at inference time.

In an LLM for RAG, the LLM generates a prediction using the user's input data (e.g., request 262) and the retrieved item data via (e.g., embedding) which is fed to the LLM to generate an output. Here, instead of using a generative LLM, the cross encoder is used, which relevantly ranks and retrieves the appropriate items (e.g., documents) in response to the request 262 (e.g., query).

Parameter tying the retrieval model (EBR) (e.g., LLMs 218, 228) with the ranking model (e.g., LLM 250) enables item inference to be performed only once to generate both the item embedding for the EBR (e.g., on-device retrieval component 242) and KV cache for the ranker component 248. In other words, because a KV cache is generated using the cross encoder (of KV pairs of e.g., query and document), the number of parameters need to be learned during training is reduced and inference only needs to be run once to generate an embedding that takes into account the KV cache and the EBR. By pre-calculating and caching the KV pairs, the Turbo RAG avoids the need to perform a real-time lookup during inference and instead can utilize the cached KV pairs to improve lookup so that it is near real-time or offline.

The cache KV pairs are stored as embeddings. When a query is provided, a lookup is performed via the ranker process (e.g., cross encoder) and LLM 250 (e.g., an 8 B LLM having 8 billion parameters) to rank relevant items (e.g., documents) from the KV cache (e.g., the item cache store 215). Thereafter, these are ranked and then a parameter tying is performed to enable inference from the EBR (e.g., the entity embedding 232 and the item embeddings 217) using the LLMs 218, 228 to retrieve relevant member interaction logs and item interaction logs which are then provided in a ranked feed. A larger offline foundation model (e.g., 100 B+parameters) can be used for training the LLMs 218, 228, 250 (e.g., 8 B LLM). The architecture of the LLMs 218, 228, 250 (e.g., 8 B LLM) is specialized for this purpose (e.g., fine-tuned for retrieval and ranking, e.g., as a student model trained by the foundation model).

The architecture of LLMs 218, 228, 250 uses a Turbo RAG and a cross encoder, which provides an improvement over conventional RAG approaches that would utilize a generative LLM to generate an output based on EBR. By using the KV cache, mass pointwise attention can be utilized across the item and entity embeddings. The embeddings (EBR and ranking) can be refreshed at any frequency because embedding generation is decoupled from the queries. By using this approach, inference is only required to be performed once for both EBR and the ranker component 248. This leads to a potential reduction of, e.g., 1/30th of the conventional GPU usage seen with conventional RAG.

The examples shown in FIG. 2 and the accompanying description are provided for illustration purposes. This disclosure is not limited to the described examples.

FIG. 3A is a component-based flow diagram illustrating an example of an architecture and operation of a cross encoder machine learning model trained to generate and output ranking scores. Portions of the description of FIG. 3A may be applicable to flows and components shown in other figures having similar names or reference numbers as flows and components shown in FIG. 3A. Similarly, portions of the description of other figures may be applicable to flows and components shown in FIG. 3A having similar names or reference numbers as flows and components shown in those other figures.

In FIG. 3A, a cross encoder machine learning model includes a decoder LLM 302 and hidden layers 304. In a method 300, the cross encoder machine learning model is used as a ranking model. In the method 300, a ranking prompt 306 is input to decoder LLM 302. The ranking prompt 306 is a combined prompt that includes both an entity prompt 308 and an item prompt 310 (e.g., the entity prompt 308 and the item prompt 310 are concatenated at the input to the decoder LLM 302.

The decoder LLM 302 generates and outputs a description (e.g., a textual description) that answers the question such as, which of these items is the entity most likely to engage with? The hidden layer 304 convert the output of the decoder LLM 302 to ranking scores 312. The ranking scores 312 are capable of being used for alignment of the ranking model with a retrieval model such as the retrieval model shown in FIG. 3B, described below.

The examples shown in FIG. 3A and the accompanying description are provided for illustration purposes. This disclosure is not limited to the described examples.

FIG. 3B is a component-based flow diagram illustrating an example of an architecture and operation of a dual encoder machine learning model trained to generate retrieval scores. Portions of the description of FIG. 3B may be applicable to flows and components shown in other figures having similar names or reference numbers as flows and components shown in FIG. 3B. Similarly, portions of the description of other figures may be applicable to flows and components shown in FIG. 3B having similar names or reference numbers as flows and components shown in those other figures.

In FIG. 3B, a retrieval model includes decoder LLM 302 in a dual encoder configuration. That is, the decoder LLM 302 of FIG. 3A and FIG. 3B is the same, single, multi-task LLM that is trained on both retrieval and ranking tasks (e.g., parameter tied and co-trained) so as to minimize the counterfactual regret relative to the complete ranking prompt (e.g., ranking prompt 306). The dual encoder configuration of FIG. 3B is a low-rank approximation of the cross encoder ranking model of FIG. 3A, for which the full prompt can be computed using on-device retrieval (e.g., on-GPU EBR). Approximation mistakes at the retrieval model are corrected by re-ranking the top results using the full cross encoder configuration of FIG. 3A. The retrieval model of FIG. 3B is trained using, e.g., importance weighted contrastive sampling and distillation (using the ranking model of FIG. 3A as a teacher model).

In a method 320, the ranking prompt of FIG. 3B is divided into two parts: entity prompt 308 and item prompt 310. Instead of a combined input, each of these prompts is input independently to decoder LLM 302. In FIG. 3B, the decoder LLM 302 could be but is not necessarily implemented as two towers having shared parameters. Instead, the decoder LLM 302 could be the same LLM to which entity prompt 308 and item prompt 310 are each separately input at different times.

In the dual encoder retrieval model of FIG. 3B, each decoder LLM 302 generates and outputs an embedding corresponding to its respective input. These embeddings are compared at a scoring function 322 (e.g., cosine similarity, dot product). The scoring function 322 outputs the retrieval score 324 for each entity-item pairs based on the respective entity and item embeddings produced by the decoder LLM 302. The retrieval score 324 is compared with the ranking score 312 of FIG. 3A to evaluate the alignment of the dual encoder retrieval model of FIG. 3B with the cross encoder ranking model of FIG. 3A using, e.g., counterfactual regret minimization.

The examples shown in FIG. 3B and the accompanying description are provided for illustration purposes. This disclosure is not limited to the described examples.

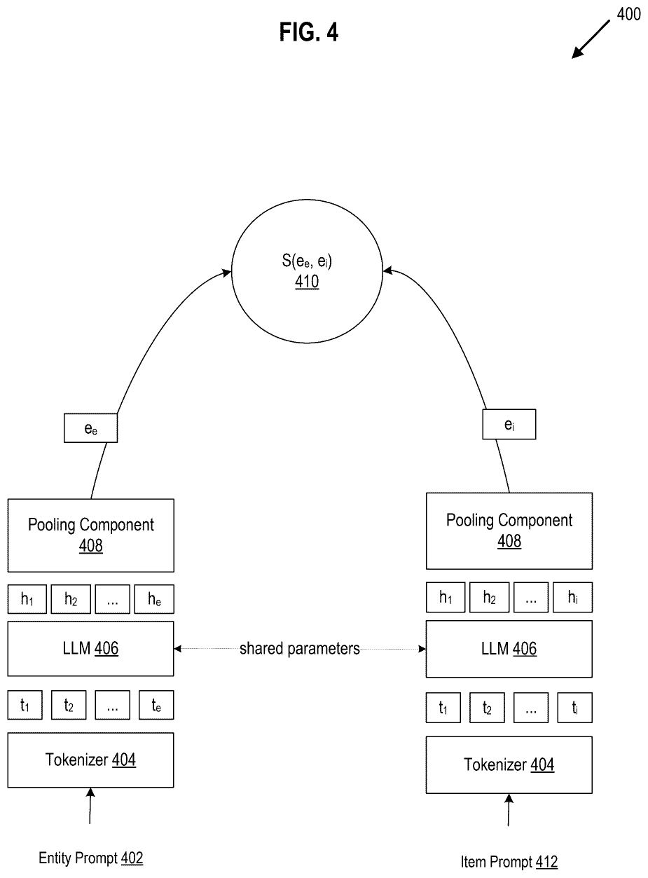

FIG. 4 is a component-based flow diagram illustrating an example of an architecture and operation of a dual encoder machine learning model trained to generate retrieval scores. The architecture shown in FIG. 4 is used to implement a dual encoder retrieval model, in some examples.

The dual encoder machine learning model of FIG. 4 is trained to generate retrieval scores using an EBR approach. The model architecture uses a deep learning model, e.g., a language model such as a shared large language model (LLM) for content-based retrieval (e.g., text-based retrieval).

At inference time, entity (e.g., user, query, organization, etc.) and item content (e.g., text, etc.) are processed separately through a tokenizer 404 and an LLM 406, thereby generating token-level hidden representations. A pooling component 408 includes a function that aggregates each these representations, respectively, into respective entity and item embeddings, which are then compared using a similarity function 410.

In some examples, the initial base model (e.g., LLM 406) is a pre-trained, decoder-only transformer-based large language model (LLM). The base LLM 406 is optimized for embedding-based retrieval (EBR) through fine-tuning using techniques described herein. Entity content (e.g., text or other digital content of a user request, query, context data such as an entity profile, etc.) and item content (e.g., feed items, posts, articles, documents, multimodal content, videos, recordings, etc.) are mapped to a shared embedding space. A dual-encoder architecture includes a single shared LLM that is used to encode both the entity content and item content.

Model input representation. In some examples, the retrieval model of FIG. 4 operates exclusively on textual data. In these examples, for items, the input includes relevant features structured in a standardized text format. For entities, the input is a concatenation of: (1) task-specific instructions, (2) entity profile attributes, and (3) a sequence of the entity's publicly available history of online interactions with items, containing both positive and negative examples.

Embedding Generation. The entity input and item input respectively undergo tokenization at the tokenizer 404 before being processed by the LLM 406. Given a tokenized sequence t of length L, the LLM 406 produces a sequence of hidden states, H∈R^{L×d} where d denotes the dimensionality of the hidden states. A pooling component 408 is subsequently applied to generate a fixed-dimensional dense representation. In some examples, the embedding for an entity token sequence t_{c} is computed as: e_{c}=pool(Hₘ). An analogous process is used to generate the item embedding eᵢ.

Measuring Entity-Item Similarity. The similarity between entity embeddings and item embeddings is quantified using a similarity function, S (e_{c}, eᵢ). In some examples, cosine similarity is used to compute the entity-item similarity. The similarity score serves as the primary retrieval ranking metric, enabling efficient identification of the most relevant items for a given entity.

Pooling. The pooling component 408 aggregates the token-level hidden states into the fixed-dimensional, dense embeddings for each of the entity and the item, respectively. In some examples, mean pooling is used as the pooling function. In mean pooling, given an input sequence consisting of L tokens with hidden states H∈R^{L×d} (with Hi as the i-th token), the pooled embedding is

$$e = \frac{1}{L} {\sum }_{i = 1}^{L} {H}_{i} .$$

The mean pooling method yields a holistic representation by averaging over all tokens.

In some examples, last token pooling is used. In last token pooling, the embedding from the final token is implemented in two variants: input sequence and learned special token. In input sequence, the embedding is taken directly from the final token of the original input sequence. In learned special token, a dedicated <embed> special token is appended to the sequence, and its hidden state is optimized to capture aggregate sequence information via the attention mechanism during training.

Training objectives. When fine-tuning for the retrieval task, the goal is to optimize an objective where embeddings of positive member-item pairs are drawn closer together in the embedding space, while negative pairs are pushed apart in the embedding space. For this objective, training data includes binary data that captures whether a positive or negative action was taken between an entity and an item. In this setting, each entity-item pair is assigned a binary label y∈{0, 1}. Loss functions that are capable of leveraging the labeled data to effectively learn embedding similarities include InfoNCE (Information Noise-Contrastive Estimation) and BCE (Binary Cross-Entropy).

InfoNCE: For a given entity embedding eₘ and a corresponding positive item embedding eᵢ₊, along with a set of negative item embeddings {eᵢ₋}, the InfoNCE loss is defined as:

$${L}_{InfoNCE} = - log \frac{exp ( \frac{s ( {e}_{m} , {e}_{i}^{+} )}{τ} )}{exp ( \frac{s ( {e}_{m} , {e}_{i}^{+} )}{τ} ) + {\sum }_{j} exp ( \frac{s ( {e}_{m} , {e}_{{i}_{j}}^{-} )}{τ} )} ,$$

where s(⋅, ⋅) denotes the similarity function used, and τ is a temperature parameter. This loss encourages the similarity of positive pairs to be higher than that of negative pairs by emphasizing relative ranking.

Binary Cross-Entropy (BCE): In this formulation, the similarity score S (e_{c}, eᵢ) is scaled by the temperature τ and interpreted as a logit. The corresponding probability is computed using the sigmoid function σ(⋅):

$$P ( y = 1 \vert {e}_{m} , {e}_{i} ) = σ ( \frac{s ( {e}_{m} , {e}_{i} )}{τ} ) .$$

The BCE loss is expressed as:

$${L}_{BCE} = - [ y log σ ( \frac{s ( {e}_{m} , {e}_{i} )}{τ} ) + ( 1 - y ) log ( 1 - σ ( \frac{s ( {e}_{m} , {e}_{i} )}{τ} ) ) ] .$$

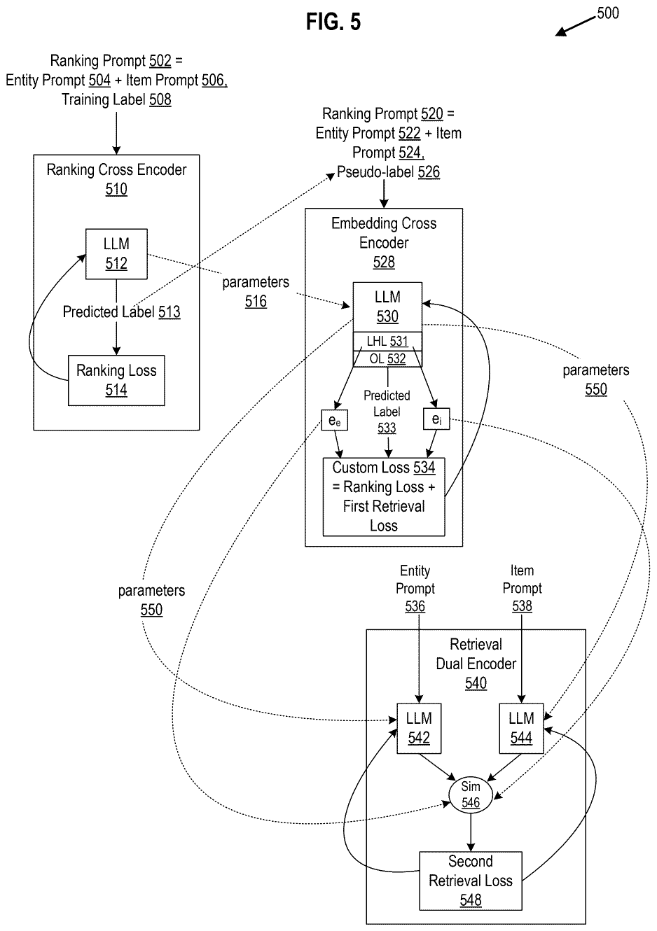

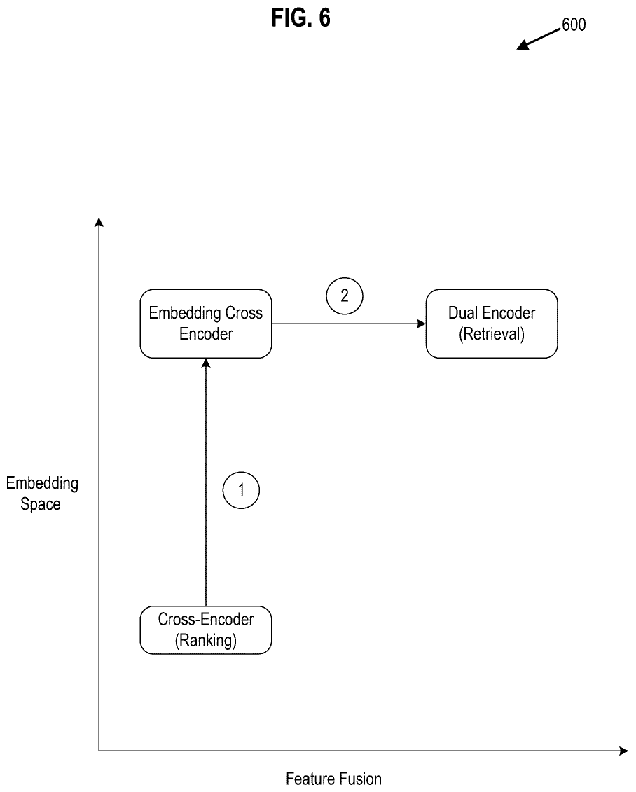

Cross Encoder Followed by Distillation. Embedding based retrieval (EBR) approaches using a dual encoder model involve generating separate entity and item embeddings for each pair in the corpus and are scored on cosine similarity. Top k candidate items are provided to a cross encoder model which uses early feature fusion (query and item context are provided pairwise). The retrieval dual encoder uses late feature fusion, which may cause misalignment between the retrieval and ranker models. In an effort to bridge this gap, an intermediary cross encoder model is trained using the loss of the retrieval dual encoder. Examples of this approach are described in more detail with reference to FIG. 5 and FIG. 6. Contextualized embeddings for both the entity and the item are extracted from the last hidden state of the model (e.g., h₁, h₂, etc.) and are pooled with attention to the entity and item sequence tokens. These extracted embeddings are leveraged during dual encoder retrieval training as oracle embeddings to enforce alignment between ranker and retrieval models.

The examples shown in FIG. 4 and the accompanying description are provided for illustration purposes. This disclosure is not limited to the described examples.

FIG. 5 is a block diagram of an example of a two stage distillation process for fine-tuning a dual encoder retrieval model from a cross encoder ranking model.

In FIG. 5, a method includes flows denoted as (1) and (2). The flow denoted as (1) is a first stage of a distillation process 500 in which an intermediary cross encoder LLM is distilled from the base cross encoder LLM, and the flow denoted as (2) is a second stage of the distillation process in which the dual encoder LLM is distilled from the intermediary cross encoder LLM, using, e.g., a cascade distillation technique.

Flow (1) of FIG. 5 includes a ranking cross encoder 510. During training of the ranking cross encoder 510, a training instance of ranking prompt 502 includes a combination of an entity prompt 504 and an item prompt 506 (early fusion) and a ground-truth training label 508. The training label 508 may be obtained from a foundation model or actual data.

During training of the ranking cross encoder 510, a training instance of the ranking prompt 502 is input to an LLM 512. The LLM 512 is a cross encoder which includes a decoder LLM such as one of the decoder LLMs described herein. In response to the ranking prompt 502, during training, the LLM 512 outputs a predicted label 513, and the predicted label 513 is evaluated using the training label 508 and a ranking loss 514. During training of the ranking cross encoder 510, the ranking loss 514 is backpropagated to the LLM 512.

After training of the ranking cross encoder 510, the trained ranking cross encoder 510 is used as a first teacher model. An embedding cross encoder 528 is a first student model that is distilled using parameters 516 of the trained ranking cross encoder 510. The embedding cross encoder 528 is a cross encoder which includes a decoder LLM such as one of the decoder LLMs described herein. The embedding cross encoder 528 is trained using a ranking prompt 520 (entity prompt 522 and item prompt 524 combined via early fusion) and pseudo labels 526. The pseudo labels 526 correspond to predicted labels 513 generated by the trained ranking cross encoder 510 at inference time in response to ranking prompt 502. Like the ranking prompt 502 for the ranking cross encoder 510, the ranking prompt 520 for the embedding cross encoder 528 includes a combination of entity prompt and item prompt as a single input (e.g., entity prompt 522 and item prompt 524 are combined at the model input).

The embedding cross encoder 528 is trained using a custom loss 534. The custom loss 534 includes both a ranking loss and a first retrieval loss. For a given training instance of the ranking prompt 520, the ranking loss of the custom loss 534 corresponds to the ranking loss 514 and includes a comparison of the predicted label 533 generated by the output layer 532 of the LLM 530 to the pseudo label 526 of the training instance.

The retrieval loss of the custom loss 534 corresponds to the second retrieval loss 548 of the retrieval dual encoder 540. During training of the embedding cross encoder 528, the first retrieval loss is computed using entity and item embeddings obtained from the last hidden layer 531 of the LLM 530 and a contrastive loss function such as InfoNCE.

During training of the embedding cross encoder 528, the custom loss 534 is backpropagated to the LLM 530.

After training of the embedding cross encoder 528, in flow (2) of FIG. 5, the trained embedding cross encoder 528 is a second teacher model. The retrieval dual encoder 540 is a second student model that is distilled using parameters 550 from the trained embedding cross encoder 528 and the embeddings obtained from the last hidden layer 531 of the LLM 530.

The retrieval dual encoder 540 includes LLMs 542, 544. The LLMs 542, 544 each includes a decoder LLM such as one of the decoder LLMs described herein. The LLMs 542, 544 are shown separately to illustrate that entity prompt 536 and item prompt 538 are separate inputs rather than a combined input to an LLM. For instance, LLMs 542, 544 may be implemented as a single LLM rather than two towers with shared parameters.

During training of the retrieval dual encoder 540, a training instance of entity prompt 536 is input to LLM 542 and a training instance of item prompt 538 is input to LLM 544. LLM 542 generates an entity embedding in response to the entity prompt 536, and LLM 544 generates an item embedding in response to the item prompt 538. A similarity function 546 generates a first similarity score based on the entity embedding that was generated by the LLM 542 in response to the entity prompt 536 and the item embedding generated by the LLM 544 in response to the item prompt 538.

During training of the retrieval dual encoder 540, the similarity function 546 is also used to generate a second similarity score for the entity and item embeddings output by the last hidden layer 531 of the embedding cross encoder 528. A second retrieval loss 548 is computed and backpropagated to the LLMs 542, 544. The second retrieval loss includes a comparison of the first similarity score, computed by the similarity function 546 based on the embeddings produced by the LLMs 542, 544 of the dual encoder 540, to the second similarity score, which is computed by the similarity function 546 based on the embeddings produced by the last hidden layer 531 of the LLM 530 of the embedding cross encoder 528. The second retrieval loss 548 is computed using the contrastive loss function, e.g., InfoNCE.

A contrastive loss function evaluates the semantic distance or similarity between positive and negative training examples in comparison to the distance between two positive examples on the theory that the distance between two positive examples is expected to be small and the distance between two negative examples should be larger than the distance between two positive examples. For instance, given a first training example that includes an item that an entity is known to have interacted with (a positive example) and a second training example that includes an item that the entity is known to have ignored (a negative example), the similarity score computed between the item embedding and the entity embedding in the first training example should be smaller than the similarity score between the item embedding and the entity embedding in the second training example.

After training of the retrieval dual encoder 540, the trained ranking cross encoder 510 and the trained retrieval dual encoder 540 are capable of being deployed in a retrieval and ranking system and used to generate recommendations such as ranked lists of items, while the embedding cross encoder 528 is not deployed in an inference-time retrieval and ranking pipeline. The embedding cross encoder 528 merely functions as an intermediary model that facilitates the distillation of the retrieval dual encoder 540 from the ranking cross encoder 510 while optimizing the alignment of these ranking and retrieval models.

Additional details of the distillation process are provided below.

Easy and Hard Negative Sampling. The negatives used for the InfoNCE loss described above are a combination of easy and hard negatives. Easy negatives are negatives sampled from across a global batch of training data (e.g., across all GPUs). Hard negatives are negative examples for an impressed item for the specific entity. Tunable parameters control how many easy and hard negatives go into each batch. These parameters may be tuned through grid search and/or with offline metrics.

Exploration of Embeddings with Special Tokens vs Mean Pool. Extending Special Token-Based Embeddings. Building upon the embedding extraction methods discussed, enhancements to the special token-based approach are provided. In some examples, multiple instances of special tokens are introduced and their impact on embedding quality is investigated.

Motivation for Multiple Special Tokens. The use of multiple special tokens is to distribute the computation across multiple inference passes of the LLM. Each special token representation acts as an independent sample, and averaging across multiple tokens can provide a more robust embedding. This method effectively distributes the computational burden over multiple forward passes of LLM, potentially improving representation quality.

Experimental Observations. Impact of Increasing Special Tokens: As the number of special tokens increases, the embedding quality improves, as measured by recall. (2) Training Efficiency: Increasing the number of special tokens increases the number of training steps needed to reach comparable recall levels. Thus, a higher number of tokens may need more data to fully optimize their embeddings.

Other methods for improving the special token-based approach: (1) Using Diverse Special Tokens: Instead of repeating the same special token, introducing multiple unique special tokens may enhance diversity in learned embeddings. (2) Smart Initialization of Special Tokens: Initializing special tokens based on the average representation of the prompt may reduce the need for extensive training data, potentially accelerating convergence.

Datasets. In some examples, the training dataset includes publicly available engagement data such as public actions in a feed that are captured and stored in a log. Historical public actions may be used for finetuning both the dual encoder and cross encoder. For the dual encoder, there are two towers: entity side and item side. On the entity side, publicly available entity context information and the public contributions of users to feed posts may be used to develop historical interaction sequences. On the item side, the content of an item (e.g., the text of an article or post) is provided as input.

The examples shown in FIG. 5 and the accompanying description are provided for illustration purposes. This disclosure is not limited to the described examples.

FIG. 6 is a schematic flow diagram of an example of a two stage distillation process to fine-tune a dual encoder retrieval model from a cross encoder ranking model.

FIG. 6 illustrates a variation of the distillation approach shown in FIG. 5 and described above. In the example method 600 of FIG. 6, the base cross encoder model (ranking model) is a foundational model or teacher model that is used to train an intermediary embedding cross encoder model using distillation (training process denoted by (1)), and then the intermediary cross encoder model is used to train the bi-encoder (or dual encoder) retrieval model using distillation (training process denoted by (2)).

As shown by the plot superimposed on the flow diagram, the base cross encoder ranking model is not trained to map items to a metric space (also referred to as an embedding space) and does not use late feature fusion (also referred to as feature interaction). That is, the base cross encoder model uses early feature fusion (e.g., the item and entity features are fused at the input layer to the LLM). The embedding cross encoder is trained to map items to a metric space but does not use late feature fusion. The dual encoder retrieval model is trained to map items to a metric space and uses late feature fusion. In late feature fusion, the tokens in the model input are processed by intermediate layers of the model and are joined together (e.g., concatenated) subsequently to the processing by those intermediate layers. Thus, in the approach shown in FIG. 6, the metric space is introduced in the first stage (1) of distillation and the late fusion is introduced in the second stage (2) of distillation.

In contrast to other approaches that distill directly from a base cross encoder to a dual encoder (e.g., without using an intermediary model), or which introduce late fusion in the first stage of distillation and then introduce the metric space in the second stage, the specifically described two stage distillation process provides for better alignment between the ranking and retrieval models because the resulting retrieval model better approximates the base ranking model. Also, introducing late feature fusion at the second stage reduces latency without sacrificing model accuracy. The described approach uses lossy compression to discard less critical and relevant information, which helps reduce the model size and complexity, making it more suitable for providing near-real time or real time recommendations.

In the first stage of distillation, in some examples, the base cross encoder ranking model is used to train an embedding cross encoder using early feature fusion and with an objective of learning a metric space. The embedding cross encoder has a different architecture than the cross encoder ranking model, which enables it to be trained on multiple tasks. In some examples, the embedding cross encoder is trained on two tasks: ranking and retrieval. In the ranking training phase, the cross encoder ranking model is used to generate training labels (also referred to as pseudo labels or soft labels, because those labels are model-generated as opposed to ground-truth labels), and the cross encoder ranking model performs the training on the embedding cross encoder using those pseudo labels and supervised machine learning (e.g., without using embeddings).

For the ranking task, for a given entity-item pair, the input is a concatenation of the entity and item features (e.g., early fusion) and then the output of the ranking model is a ranking score for the respective early-fused combination of entity features and item features. For the retrieval task, for a given entity-item pair, the entity features and item features are separate inputs and the output is a measure of similarity between an embedding of the entity features and an embedding of the item features. In the first stage of distillation to create the embedding cross encoder from the cross encoder ranking model, during the training on the retrieval task, a Multi-Margin MSE (Means Squared Error) or M3SE equation is used as the loss function, in some examples. In some examples, the M3MSE is designed to optimize the margins between positive and negative samples by matching the margins for the highest scoring negative sample while encouraging all other negatives to have lower scores. This approach may help achieve better margin distribution and consequently improve re-ranking performance at the ranking stage.

In the second stage of distillation, the embedding cross encoder (created via distillation of the cross encoder as described above) is used to train the dual encoder retrieval model on the retrieval task. To train the dual encoder on the retrieval task, for a given entity-item pair, the input is separate inputs of the entity and item features (e.g., late fusion) for each entity-item pair along with training labels based on similarity scores generated by the embedding cross encoder. For an entity-item pair, the output is a measure of similarity between the embedding of the entity features and the embedding of the item features, which is computed as, e.g., a dot product of the entity embedding and the item embedding.

In the second stage of distillation to create the bi encoder retrieval model from the embedding cross encoder, during the training on the retrieval task, the InfoNCE (Information Noise-Contrastive Estimation) equation is used as the loss function, in some examples. InfoNCE is a type of contrastive loss function used for self-supervised learning. The InfoNCE loss function optimizes the density ratio between positive and negative samples, which may help in learning effective representations for retrieval tasks. InfoNCE works by maximizing the similarity between positive pairs (e.g., samples that are similar) while minimizing the similarity between negative pairs (samples that are dissimilar). InfoNCE may be used to learn an embedding space that separates similar and dissimilar samples.

The overall goal of the distillation process is to produce a dual encoder retrieval model whose output approximates the output of the cross encoder ranking model (also referred to as alignment) as closely as possible. The described approach in which metric space is learned first and then late feature fusion is applied subsequently has been shown to reduce the amount of misalignment between the dual encoder retrieval model and the cross encoder ranking model when compared to other distillation approaches, including other cascade distillation approaches.

After training, the dual encoder retrieval model and the cross encoder ranking model may be deployed in an online ranking and retrieval pipeline, while the embedding cross encoder may be discarded (or not used for inference or serving). In a ranking and retrieval pipeline, the dual encoder retrieval model retrieves a first set of items that could potentially be included in, e.g., a user's feed, and then that first set of items is input to the cross encoder ranking model for ranking. A second set of items, which is a subset of the first set of items, is selected based on the ranking provided by the ranking model, and those selected items may be routed to a user's device, e.g., for inclusion in the user's feed.

Online Deployment. To run the retrieval stage in an online environment for serving entity requests (e.g., queries), workflows such as the online and nearline workflows shown in FIG. 1 and FIG. 2, described above, are constructed, in some examples.

Nearline item & entity activity log generation. When items or entities are created or updated on an online platform, those updates are stored into an item and entity activity log. When entities interact with items (e.g., view, like, comment, share, etc.) on the platform, those interactions, if publicly available, may be captured by processing tracking data into the item and entity activity log. The latency in capturing these interactions is reduced by using direct RPC (remote procedure calls) calls for service to service communication over nearline stream processing, in some examples.

Nearline item & entity prompt generation. The item and entity activity logs are processed into corresponding item and entity prompts using, e.g., pre-defined prompt templates where data like item text, entity profile information, and item popularity counts are fetched and populated into the prompt templates to construct prompts that include interaction history. The inclusion of up to date interaction data improves the freshness of prompt data. In some examples, these fully decorated prompts are pushed to a key-value store for online access during ranking and to a nearline stream processor for generating embeddings.

Nearline item and entity embedding generation using online LLM inference. The updated item prompts for each item creation and item update are fed into an LLM (e.g., the bi encoder retrieval model fine-tuned using a technique described above) to generate respective item and entity embeddings as described above.

In some examples, the generated item embeddings are ingested into a GPU (graphics processing unit)-based retrieval and ranking (GPU-RAR) index for online kNN (k-nearest neighbors) retrieval. Updated entity prompts for each entity creation and entity interaction activity are fed to the fine-tuned bi encoder LLM to generate embeddings. In some examples, the entity embeddings are ingested into an online key-value store for access during online retrieval. In some examples, this embedding generation process is done using nearline stream processing to control the LLM inference rate by batching updates in configurable window sizes if the scale results in thousands of input prompt updates per second. In some examples, GPU compute used is balanced against embedding freshness by using shorter window sizes for increased freshness which helps capture evolving entity interests and item popularity. Newly created items are indexed in the GPU-RAR index within minutes or less of creation and newly added entities and existing entity activity/interactions on items are captured in their entity query embeddings within minutes or less of interaction activity.

Online GPU-RAR kNN retrieval with Attribute Based Matching. To serve an online feed query for an entity, in some examples, entity query embeddings generated as described above are fetched and run online. In some examples, kNN is applied against the GPU-RAR item embeddings index to retrieve top K items, while applying business logic filtering and privacy rules, that are then sent to the ranker layer. The pre-computation of embeddings allows us to achieve sub-50 ms retrieval latency for serving tens of thousands of queries per second on a corpus of hundreds of millions of items while maintaining embedding freshness in single digit minutes.

Using LLMs to capture count features for ranking. One of the challenges in using embeddings for the retrieval stage is that the features that are important for the ranking model may not be captured in the embeddings learned in the retrieval model. For instance, item popularity historically is not captured by the embedding model but is one of the important features for the ranking model. Thus, in a retrieval and ranking pipeline in which the output of the retrieval model is input to the ranking model, a lack of item popularity data would have a significant impact in the performance metrics for the ranking model.

In some examples, item popularity data is captured as a popularity rate (e.g., in percentage values from 0 to 100) and added to the training data to both the public engagement history on the query side and to the prospective items for recommendation on the item side. In some examples, the size or length (e.g., in characters or tokens) is restricted to help ensure that the model captures other useful metadata added in the generated embeddings. The training framework described above is applied with these adjustments to the training data, in some examples.

The examples shown in FIG. 6 and the accompanying description are provided for illustration purposes. This disclosure is not limited to the described examples.

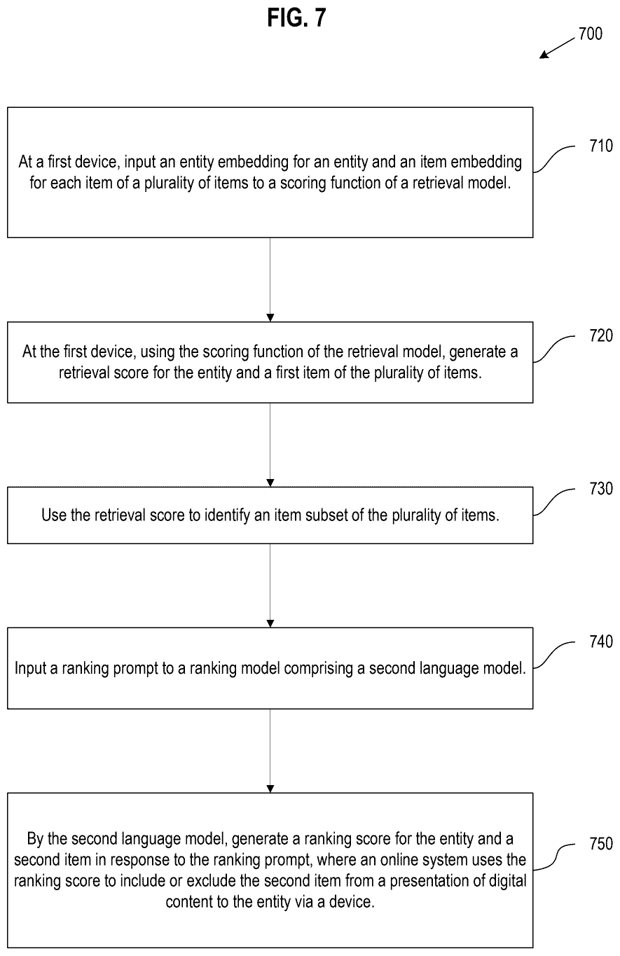

FIG. 7 is a flow diagram of an example method in accordance with some examples of the present disclosure.

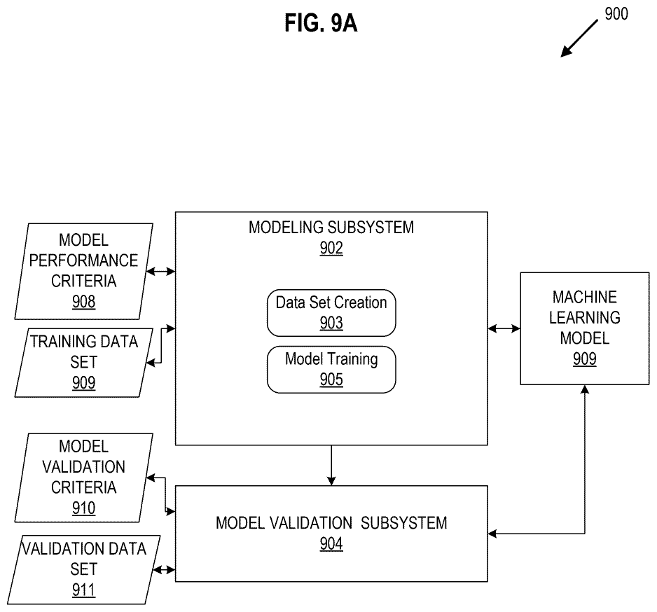

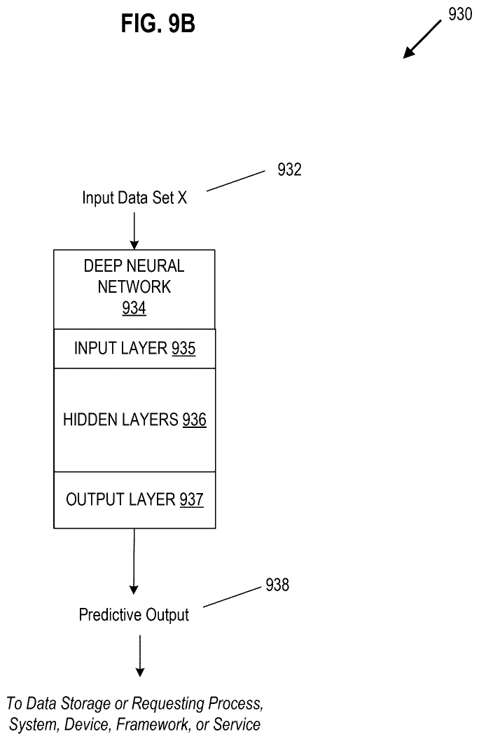

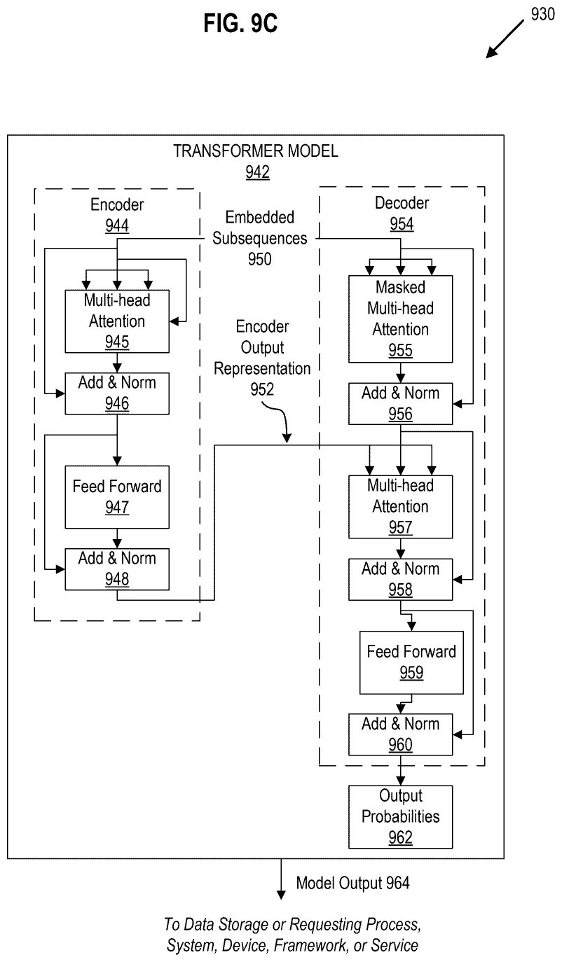

For instance, FIG. 7 illustrates a method 700. The method 700 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the portions of the method 700 are performed by the computing system components shown in FIG. 7. In other examples, portions of the method 700 are performed by one or more computing system components shown in FIG. 1, FIG. 2, FIG. 3A, FIG. 3B, FIG. 4, FIG. 5, FIG. 6, one or more components of computing system 800 of FIG. 8, one or more components of FIG. 9A, FIG. 9B, and/or FIG. 9C, and/or one or more components of computer system 1000 of FIG. 10. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

At operation 710, at a first device, an entity embedding for an entity and an item embedding for each item of a plurality of items are input to a scoring function of a retrieval model. In some examples, the entity embedding and the item embedding are pre-computed at a second device using a first language model of the retrieval model. In some examples, portions of the online system of operation 710 are performed by one or more processes and/or components described with reference to, e.g., FIG. 1, FIG. 2, FIG. 3B, and/or FIG. 4.

In some examples, the entity embedding is pre-computed by inputting the entity prompt into an entity-side encoder of the first language model and the item embedding is pre-computed by inputting the item prompt into an item-side encoder of the first language model.

At operation 720, at the first device, using the scoring function of the retrieval model, a retrieval score is generated for the entity and a first item of the plurality of items. In some examples, portions of the online system of operation 720 are performed by one or more processes and/or components described with reference to, e.g., FIG. 1, FIG. 2, FIG. 3B, and/or FIG. 4.

In some examples, the first language model of the retrieval model includes a dual encoder, which includes a decoder-only language model, and the dual encoder including the decoder-only language model is used to generate the retrieval score. In some examples, the retrieval score is computed at the first device using the entity embedding and an index of item embeddings for the plurality of items.

At operation 730, a processing device uses the retrieval score to identify an item subset of the plurality of items. In some examples, the first item is excluded from the item subset. In some examples, portions of the online system of operation 730 are performed by one or more processes and/or components described with reference to, e.g., FIG. 1, FIG. 2, FIG. 3B, and/or FIG. 4.

At operation 740, the processing device inputs a ranking prompt to a ranking model including a second language model. In some examples, the second language model and the first language model have a common parameter value. In some examples, portions of the online system of operation 730 are performed by one or more processes and/or components described with reference to, e.g., FIG. 1, FIG. 2, and/or FIG. 3A.

In some examples, the processing device includes, in the ranking prompt, a combination of an entity prompt and an item prompt. In some examples, the entity prompt includes a ranking instruction and entity interaction data for the entity, and the item prompt includes item interaction data for each item of the item subset. In some examples, the ranking instruction instructs the second language model to generate and output a likelihood of engagement of the entity with the each item of the item subset using the entity interaction data and the item interaction data.

At operation 750, the processing device, by the second language model, generates a ranking score for the entity and a second item in response to the ranking prompt. In some examples, the second item is included in the plurality of items and the item subset. In some examples, an online system uses the ranking score to include or exclude the second item from a presentation of digital content to the entity via a device. In some examples, portions of the online system of operation 730 are performed by one or more processes and/or components described with reference to, e.g., FIG. 1, FIG. 2, and/or FIG. 3A.

In some examples, the second language model of the ranking model includes a cross encoder including the decoder-only language model, and the cross encoder including the decoder-only language model is used to generate the ranking score.

In some examples, the first device includes a graphics processing unit (GPU), and item caches are concatenated at the GPU. The concatenated item caches are stored at the GPU using a block attention mechanism.

In some examples, the first device includes a graphics processing unit (GPU), the second device is different from the first device, and the ranking score is generated at the second device.

In some examples, a matrix superimposition mechanism is used to superimpose items of the item subset to produce a superimposed item subset; and ranking scores are concurrently generated for the items using the superimposed item subset.

In some examples, the processing device concurrently sends a first call to the retrieval model and a second call to the ranking model, the retrieval model identifies the item subset in response to the first call and the ranking model stores an entity prompt in a cache in response to the second call.

In some examples, the processing device joins the item subset identified by the retrieval model with the entity prompt stored in the cache; and uses the cache to formulate the ranking prompt.

The examples shown in FIG. 7 and the accompanying description are provided for illustration purposes. This disclosure is not limited to the described examples.

FIG. 8 is a block diagram of a computing system that includes embedding generation in accordance with some examples of the present disclosure.

In the example of FIG. 8, a computing system 800 includes one or more user systems 810, a network 820, an application system 830, data resources and tools 850, a retrieval and ranking system 880, a data storage system 860, an event logging service 870, and an AI model service 890.

All or at least some components of retrieval and ranking system 880 are implemented at the user system 810, in some examples. For example, portions of retrieval and ranking system 880 are implemented directly upon a single client device such that communications involving applications running on user system 810 and retrieval and ranking system 880 occur on-device without the need to communicate with, e.g., one or more servers, over the Internet. Dashed lines are used in FIG. 8 to indicate that all or portions of retrieval and ranking system 880 are capable of being implemented directly on the user system 810, e.g., the user's client device. In some examples, both user system 810 and retrieval and ranking system 880 are implemented on the same computing device, in some examples. In other examples, all or portions of retrieval and ranking system 880 are implemented on one or more servers and in communication with user systems 810 via network 820. Components of the computing system 800 including the retrieval and ranking system 880 are described in more detail herein.

A user system 810 includes one or more computing devices. Examples of computing devices include a personal computing device, a server, a mobile computing device, a wearable electronic device, or a smart appliance. The user system 810 includes one or more software applications that a computing device is capable of executing alone or in combination with one or more other computing devices. Examples of software applications include an operating system or a front end of an online system. Many different user systems 810 are capable of being connected to network 820 at the same time or at different times. In some examples, different user systems 810 contain similar components as described in connection with the illustrated user system 810. In some examples, many different end users of computing system 800 interact with many different instances of application system 830 through their respective user systems 810, at the same time or at different times.

User system 810 includes a user interface 812. User interface 812 is installed on user system 810 or accessible to user system 810 via network 820. In some examples, user interface 812 includes a front end portion of a search application or retrieval and ranking system.

User interface 812 includes, for example, a graphical display screen that includes graphical user interface elements. Examples of graphical user interface elements include an input box or other input mechanism and a slot. A slot as used herein refers to a space on a graphical display such as a web page or mobile device screen, into which output, e.g., digital content such as search results, feed items, chat boxes, or threads, is loaded for display to the user. In some examples, user interface 812 includes a scrollable arrangement of variable-length slots that simulates an online chat or instant messaging session and/or a scrollable arrangement of slots that contain content items or search results. The locations and dimensions of a particular graphical user interface element on a screen are specified using, for example, a markup language such as HTML (Hypertext Markup Language). On a typical display screen, a graphical user interface element is defined by two-dimensional coordinates. In other examples such as virtual reality or augmented reality examples, a slot is defined using a three-dimensional coordinate system. Example screen captures of user interface screens that are capable of being included in user interface 812 are shown in the drawings and described herein.

User interface 812 is capable of interacting with the retrieval and ranking system 880 and/or one or more application systems 830. For example, user interface 812 enables the user of a user system 810 to interact with the retrieval and ranking system 880 to create, edit, send, view, receive, process, and organize projects, tasks, plans, search queries, search results, content items, news feeds, and/or portions of online dialogs. In some examples, user interface 812 enables the user to input requests (e.g., queries) for various different types of information, to initiate user interface events, and to view or otherwise perceive output such as data and/or digital content produced by, e.g., an application system 830, retrieval and ranking system 880, content distribution service 838 and/or search engine 840. In some examples, user interface 812 includes a graphical user interface (GUI), a conversational voice/speech interface, a virtual reality, augmented reality, or mixed reality interface, and/or a haptic interface. User interface 812 includes a mechanism for entering search queries and/or selecting search criteria (e.g., facets, filters, etc.), selecting GUI user input control elements, and interacting with digital content such as search results, entity profiles, posts, articles, feeds, and online dialogs, in some examples. Some examples of user interface 812 include web browsers, command line interfaces, and mobile app front ends. User interface 812 as used herein includes application programming interfaces (APIs) in some examples.

Network 820 includes an electronic communications network. Network 820 is implemented on any medium or mechanism that provides for the exchange of digital data, signals, and/or instructions between the various components of computing system 800. Examples of network 820 include, without limitation, a Local Area Network (LAN), a Wide Area Network (WAN), an Ethernet network or the Internet, or a terrestrial, satellite or wireless link, or a combination of any number of different networks and/or communication links.

Application system 830 includes, for example, one or more online systems that provide social network services, general-purpose search engines, specific-purpose search engines, messaging systems, content distribution platforms, e-commerce software, enterprise software, or any combination of any of the foregoing or other types of software. Application system 830 includes any type of application system that provides or enables the retrieval of and interactions with one or more forms of digital content, including machine-generated content via user interface 812. In some examples, portions of retrieval and ranking system 880 are components of application system 830. In some examples, an application system 830 includes one or more of an entity graph 832 and/or knowledge graph 834, a user connection network 15315, a content distribution service 838, and/or a search engine 840. In other examples, application system 830 interacts with retrieval and ranking system 880 to control a physical machine or device, such as a vehicle or a robot.

In some examples, a front end portion of application system 830 operates in user system 810, for example as a plugin or widget in a graphical user interface of a web application, mobile software application, or as a web browser executing user interface 812. In an example, a mobile app or a web browser of a user system 810 transmits a network communication such as an HTTP request over network 820 in response to user input that is received through a user interface provided by the web application, mobile app, or web browser, such as user interface 812. A server running application system 830 receives the input from the web application, mobile app, or browser executing user interface 812, performs one or more operations using the input, and returns output to the user interface 812 using a network communication such as an HTTP response, which the web application, mobile app, or browser receives and processes at the user system 810.

In the example of FIG. 8, an application system 830 includes an entity graph 832 and/or a knowledge graph 834. Entity graph 832 and/or knowledge graph 834 include data organized according to graph-based data structures that are searchable or traversable via queries and/or indexes to determine relationships between entities. In some examples, entity graph 832 and/or knowledge graph 834 is used to compute various types of relationship weights, affinity scores, similarity measurements, and/or statistics between, among, or relating to entities.

Entity graph 832, knowledge graph 834 includes a graph-based representation of data stored in data storage system 860, described herein. For example, entity graph 832, knowledge graph 834 represents entities, such as users, organizations (e.g., companies, schools, institutions), content items (e.g., job postings, announcements, articles, comments, and shares), and computing resources (e.g., databases, models, applications, and services), as nodes of a graph. Entity graph 832, knowledge graph 834 represents relationships, also referred to as mappings or links, between or among entities as edges, or combinations of edges, between the nodes of the graph. In some examples, mappings between different pieces of data used by an application system 830 are represented by one or more entity graphs. In some examples, the edges, mappings, or links indicate relationships, online interactions, or activities relating to the entities connected by the edges, mappings, or links. In some examples, if a user clicks on a search result, an edge is created connecting the user entity with the search result entity in the entity graph, where the edge is tagged with a label such as “viewed.” If a user viewing a list of search results skip over a search result without clicking on the search result, an edge is not created between the user entity and the search result entity in the entity graph, in some examples.

Portions of entity graph 832, knowledge graph 834 are automatically re-generated or updated from time to time based on changes and updates to the stored data, e.g., updates to entity data and/or activity data. In some examples, entity graph 832, knowledge graph 834 refers to an entire system-wide entity graph or to only a portion of a system-wide graph. In some examples, entity graph 832, knowledge graph 834 refers to a subset of a system-wide graph, where the subset pertains to a particular user or group of users of application system 830.

Knowledge graph 834 includes a graph-based representation of data stored in data storage system 860, described herein. Knowledge graph 834 represents relationships, also referred to as links or mappings, between entities or concepts as edges, or combinations of edges, between the nodes of the graph. In some examples, mappings between different pieces of data used by application system 830 or across multiple different application systems are represented by the knowledge graph 834.

In some examples, knowledge graph 834 is a subset or a superset of entity graph 832. In some examples, knowledge graph 834 includes multiple different entity graphs 832 that are joined by cross-application or cross-domain edges. In some examples, knowledge graph 834 joins entity graphs 832 that have been created across multiple different databases or across different software products. In some examples, the entity nodes of the knowledge graph 834 represent concepts, such as product surfaces, verticals, or application domains. In some examples, knowledge graph 834 includes a platform that extracts and stores different concepts that is used to establish links between data across multiple different software applications. Examples of concepts include topics, industries, and skills. As with other portions of entity graph 832, knowledge graph 834 is usable to compute various types of relationship weights, affinity scores, similarity measurements, and/or statistical correlations between or among entities and/or concepts.

In the example of FIG. 8, application system 830 includes a user connection network 836. User connection network 836 includes, for instance, a social network service, professional social network system and/or other social graph-based applications. Content distribution service 838 includes, for example, a feed, chatbot or chat-style system, or a messaging system, such as a peer-to-peer messaging system that enables the creation and exchange of messages between users of application system 830 and the application system 830. Search engine 840 includes a search engine that enables users of application system 830 to input and execute search queries to retrieve information from one or more sources of information, such as user connection network 836, entity graph 832, knowledge graph 834, one or more data stores of data storage system 860, or one or more data resources and tools 850.

In the example of FIG. 8, application system 830 includes a content distribution service 838. The content distribution service 838 includes a data storage service, such as a web server, which stores digital content items, and transmits digital content items to users via user interface 812. In some examples, content distribution service 838 processes requests from, for example, application system 830 and/or retrieval and ranking system 880, and distributes digital content items to user systems 810 in response to requests.

A request includes, for example, a network message such as an HTTP (HyperText Transfer Protocol) request for a transfer of data from an application front end to the application's back end, or from the application's back end to the front end, or, more generally, a request for a transfer of data between two different devices or systems, such as data transfers between servers and user systems. A request is formulated, e.g., by a browser or mobile app at a user device, in connection with a user interface event such as a login, click on a graphical user interface element, an input of a search query, or a page load. In some examples, content distribution service 838 is part of application system 830. In other examples, content distribution service 838 interfaces with application system 830 and/or retrieval and ranking system 880, for example, via one or more application programming interfaces (APIs).

In the example of FIG. 8, application system 830 includes a search engine 840. Search engine 840 includes a software system designed to search for and retrieve information by executing queries on one or more data stores, such as databases, connection networks, and/or graphs. The queries are designed to find information that matches specified criteria, such as keywords and phrases contained in user input and/or system-generated queries. For example, search engine 840 is used to retrieve data in response to user input and/or system-generated queries, by executing queries on various data stores of data storage system 860 and/or data resources and tools 850, or by traversing entity graph 832, knowledge graph 834.

Data resources and tools 850 include computing resources, such as data stores, databases, embedding-based retrieval mechanisms, code generators, etc., that are capable of being used to operate a retrieval and ranking system. Data resources and tools 850 include computing resources that are internal to application system 830 or external to application system 830. Examples of data resources and tools 850 include entity graphs, knowledge graphs, indexes, databases, networks, applications, machine learning, taxonomies, data services, web pages, vectors (e.g., data stores that store embeddings), and searchable digital catalogs. Each data resource or tool 850 enables a retrieval and ranking system to access the data resource or tool, for example by providing an application programming interface (API). Each data resource or tool 850 includes a monitoring service that periodically generates, publishes, or broadcasts availability and/or other performance metrics associated with the data resource, in some examples. A data resource or tool 850 provides a set of APIs that are used by a retrieval and ranking system to access the data resource or tool, obtain output from the data resource, and/or obtain performance metrics for the data resource or tool, in some examples.

Data storage system 860 includes data stores and/or data services that store digital data received, used, manipulated, and produced by application system 830 and/or retrieval and ranking system 880, including contextual data, state data, prompts and/or prompt templates for machine learning models, e.g., large language models, user inputs, system-generated outputs, metadata, attribute data, activity data, etc. Databases or data stores that are capable of being used in some of the described examples include but are not limited to vector databases, graph databases, relational databases, and key value stores.

In the example of FIG. 8, data storage system 860 includes various data stores that store, for example, entity data, context data, prompts, embeddings, etc. A data store includes a volatile memory such as a form of random access memory (RAM) and/or persistent memory, which can be available on user system 810 or another device (e.g., one or more servers) for storing state data generated at the user system 810 or an application system 830. In some examples, a separate, personalized version of each or any data store is created for each user such that data is not shared between or among the separate, personalized versions of the data stores.

In some examples, data storage system 860 includes multiple different types of data storage and/or a distributed data service. In some examples, data service refers to a physical, geographic grouping of machines, a logical grouping of machines, or a single machine. In some examples, a data service includes a data center, a cluster, a group of clusters, or a machine. Data stores of data storage system 860 are capable of storing data produced by real-time and/or offline (e.g., batch) data processing. A data store configured for real-time data processing is referred to as a real-time data store, in some examples. A data store configured for offline or batch data processing is referred to as an offline data store, in some examples. Data stores are capable of being implemented using databases, such as key-value stores, relational databases, and/or graph databases. Data is written to and read from data stores using query technologies, e.g., SQL or NoSQL.

Data storage system 860 resides on one or more persistent and/or volatile storage devices that reside within the same local network as other devices of computing system 800 and/or in a network that is remote relative to other devices of computing system 800. Thus, although depicted as being included in computing system 800, portions of data storage system 860 are part of computing system 800 or accessed by computing system 800 over a network, such as network 820, in some examples.

Event logging service 870 captures and records activity data generated during operation of application system 830 and/or retrieval and ranking system 880, including user interface events generated at user systems 810 via user interface 812, in real time, and formulates the user interface events and/or other network activity data into a data stream that is consumed by, for example, a stream processing system. Examples of network activity data include logins, page loads, dialog inputs, input of search queries or query terms, selections of facets or filters, clicks on search results or graphical user interface control elements, scrolling lists of search results, and social action data such as likes, shares, comments, and social reactions (e.g., “insightful,” “curious,” “like,” etc.). For instance, when a user of application system 830 via a user system 810 enters input or clicks on a user interface element, such as a workflow element, or a user interface control element such as a view, comment, share, or reaction button, or uploads a file, or inputs a query, or scrolls through a feed, etc., event logging service 870 fires an event to capture and store log data including an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web applications and mobile applications.

For instance, when a user enters input or reacts to system-generated output, such as a list of search results, event logging service 870 stores the corresponding event data in a log. Event logging service 870 generates a data stream that includes a record of real-time event data for user interface events that have occurred. Event data logged by event logging service 870 is pre-processed and anonymized as needed.

Retrieval and ranking system 880 includes any one or more of the components, features, or functions described herein with respect to a retrieval and ranking process or component thereof, including those described with reference to FIG. 1, FIG. 2, FIG. 3A, FIG. 3B, FIG. 4, FIG. 5, FIG. 6, FIG. 7, FIG. 9A, FIG. 9B, FIG. 9C, and/or FIG. 10.

Artificial intelligence (AI) model service 890 includes one or more machine learning models such as discriminative and/or generative models, neural networks, probabilistic models, statistical models, transformer-based models, language models, and/or any combination of any of the foregoing, and/or associated services. AI model service 890 enables retrieval and ranking systems to access to these models, e.g., by providing one or more application programming interfaces (APIs). In some examples, AI model service 890 includes a monitoring service that periodically generates, publishes, or broadcasts latency and/or other performance metrics associated with the models. In some examples, AI model service 890 provides a set of APIs that are used by a retrieval and ranking system to obtain performance metrics for one or more machine learning models.

While not specifically shown, it should be understood that any of user system 810, application system 830, data resources and tools 850, data storage system 860, event logging service 870, retrieval and ranking system 880, and AI model service 890 includes an interface embodied as computer programming code stored in computer memory that when executed causes a computing device to enable bidirectional communication with any other of user system 810, application system 830, data resources and tools 850, data storage system 860, event logging service 870, retrieval and ranking system 880, and AI model service 890 using a communicative coupling mechanism. Examples of communicative coupling mechanisms include network interfaces, inter-process communication (IPC) interfaces and application program interfaces (APIs).

Each of user system 810, application system 830, data resources and tools 850, data storage system 860, event logging service 870, retrieval and ranking system 880, and AI model service 890 is implemented using one or more computing devices that are communicatively coupled to electronic communications network 820. Any of user system 810, application system 830, data resources and tools 850, data storage system 860, event logging service 870, retrieval and ranking system 880, and AI model service 890 are capable of being bidirectionally communicatively coupled by network 820. User system 810 as well as other different user systems (not shown) are bidirectionally communicatively coupled to application system 830 and/or retrieval and ranking system 880, in some examples.

Examples of users of user system 810 include an administrator, digital agent, or end user of application system 830 or retrieval and ranking system 880. User system 810 is configured to communicate bidirectionally with any of application system 830, data resources and tools 850, data storage system 860, event logging service 870, retrieval and ranking system 880, and AI model service 890 over network 820.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 810, application system 830, data resources and tools 850, data storage system 860, event logging service 870, retrieval and ranking system 880, and AI model service 890 are implemented using computer software, hardware, or software and hardware, and include combinations of automated functionality, data structures, and digital data, which are represented schematically in the figures. User system 810, application system 830, data resources and tools 850, data storage system 860, event logging service 870, retrieval and ranking system 880, and AI model service 890 are shown as separate elements in FIG. 8 for ease of discussion but, except as otherwise described, the illustration is not meant to imply that separation of these elements is required. The illustrated systems, services, and data stores (or their functionality) of each of user system 810, application system 830, data resources and tools 850, data storage system 860, event logging service 870, retrieval and ranking system 880, and AI model service 890 are capable of being divided over any number of physical systems, including a single physical computer system, and are capable of communicating with each other in any appropriate manner.

In the example of FIG. 10, portions of retrieval and ranking system 880 that are capable of being implemented on a front end system, such as one or more user systems, and portions of retrieval and ranking system 880 that are capable of being implemented on a back end system such as one or more servers, are collectively represented as retrieval and ranking system 1050 for ease of discussion only. In some examples, portions of retrieval and ranking system 880 are not required to be implemented all on the same computing device, in the same memory, or loaded into the same memory at the same time. In some examples, access to portions of retrieval and ranking system 880 is limited to different, mutually exclusive sets of user systems and/or servers. In some examples, a separate, personalized version of retrieval and ranking system 880 is created for each user of the retrieval and ranking system 880 such that data is not shared between or among the separate, personalized versions of the retrieval and ranking system 880. Certain portions of retrieval and ranking system 880 are capable of being implemented on user systems while other portions of retrieval and ranking system 880 are capable of being implemented on a server computer or group of servers. Retrieval and ranking system 880 is entirely implemented on user systems, e.g., client devices, in some examples. In some examples, a version of retrieval and ranking system 880 is embedded in a client device's operating system or stored at the client device and loaded into memory at execution time.

The examples shown in FIG. 8 and the accompanying description, above are provided for illustration purposes. This disclosure is not limited to the described examples.

FIG. 9A, FIG. 9B, and FIG. 9C are block diagrams of examples of machine learning models portions of which are usable by and/or included in a retrieval and ranking system in accordance with some examples of the present disclosure.

Machine learning models are computer-implemented structures that are capable of generating predictive output in response to input. A machine learning model includes a probabilistic or statistical algorithm that is configured to perform a specific predictive function through a training process that involves iteratively exposing the models to many samples of data and adjusting one or more model parameters until the models achieve a satisfactory prediction accuracy and reliability. The predictive accuracy and reliability of a machine learning model in relation to a particular task is dependent upon the training process and the data used in the training.

Machine learning systems include components and processes that perform data generation, model training, model evaluation, and application. Data preparation includes obtaining and aggregating model input data. The preparation of training data includes labeling the aggregated data, in some examples. Training data includes structured data, unstructured data, text, multimodal data, or any combination of any of the foregoing. Model training includes setting values of hyperparameters, determining performance metrics, adjusting weights of the machine learning model in response to the training data, evaluating the performance metrics, and parameter tuning. Application includes applying the trained machine learning model to the real-world environment, e.g., in a specific use case using data not included in the training data (e.g., unlabeled data). The application phase is referred to as inferencing or inference time, in some examples.

In FIG. 9A, a machine learning modeling system 900 includes a machine learning model 906, a modeling subsystem 902, and a model validation subsystem 904. The machine learning model 906 is any type or combination of one or more machine learning models, such as any of the types of machine learning models shown in FIG. 9B and/or any other types or combinations of machine learning models.

The modeling subsystem 902 receives model input, such as input feature sets, embeddings, digital content, or prompts. The model input is engineered to train the machine learning model 906 to perform one or more tasks, such as discriminative tasks like classification, scoring and/or generative tasks such as content generation tasks. Modeling subsystem 902 includes a data set creation component 903, and a model training component 905.

Data set creation component 903 divides the model input, e.g., input data sets, into one or more training data sets and one or more validation data sets, e.g., training data set 909 and validation data set 911. In some examples, train refers to an iterative process of applying an algorithm to one or more sets of training data, analyzing the output of the AI model in comparison to expected model output using a loss function (also referred to as a cost function or error function), adjusting values of one or more parameters and/or coefficients of the AI model, and repeating the process until the difference between the actual model output and the expected model output falls within an acceptable range of error or tolerance.

Model training component 905 executes a training process. In some examples, the training process causes the machine learning model 906 to develop, by iterative adjustments to weights or coefficients, a mathematical representation of the relationships between different items of data, such as relationships between different inputs (e.g., similarity estimates or estimates of user preferences), or relationships between inputs and categorical data such as classification labels, or relationships between inputs and outputs. The resulting trained model is used to generate predictive output (e.g., scores, labels, or other output) based on subsequent model input.

One or more different approaches are used to train the machine learning model 906, for example, supervised machine learning, semi-supervised machine learning, or unsupervised machine learning. In supervised machine learning, the set of training data includes indications of expected model output coupled with respective model input; for example, ground-truth labeled data samples. In some examples, an instance of training data for supervised learning includes a model input (e.g., a set of features) and an associated expected output (e.g., a classification label), where the expected output is human curated or machine-generated. In some examples, an instance of training data for supervised machine learning includes a digital image and a title or caption for the image that describes the contents of the image. In unsupervised machine learning, the training examples are unlabeled. In unsupervised machine learning, a machine learning algorithm such as a clustering algorithm is used to identify similarities among data samples and create clusters or groupings of similar data using one or more similarity criteria. In some examples, unsupervised learning is used to group digital content items, such as images, articles, or videos, into topics, where the topics are determined based on the features of the content items themselves rather than supplied by labels. Semi-supervised machine learning combines supervised and unsupervised machine learning, using both labeled and unlabeled data to train machine learning models.

Model training component 905 applies machine learning model 906 to training data set 909 iteratively and adjusts the value of one or more model parameters and/or feature coefficients of the machine learning model 906 based on the processing of the training data set 909 by the model 906 until an evaluation of the predicted model output generated by the machine learning model 906 and the expected model output evidenced by the training data set 909 indicates that the model satisfies (e.g., meets or exceeds) model performance criteria 908. When the model performance criteria 908 are satisfied, modeling subsystem 902 ends the model training process and produces a trained machine learning model 906.

Model validation subsystem 904 applies a model validation process to the trained machine learning model 906 produced by modeling subsystem 902. Model validation subsystem 904 uses the validation data set 911 to determine whether model validation criteria 910 are satisfied (e.g., met or exceeded). In some examples, the validation data set 911 is created by setting aside a portion of the training data set 909 until after training, such that the validation data set 911 is used to compare the predictive output produced by the trained model to the expected model output evidenced by the set-aside portion of the training data set 909.

A validated machine learning model 906 is used for inferencing, e.g., to generate predictive output, e.g., labels, scores, or other content, in response to model input. Alternatively or in addition, the output produced by the validated machine learning model 906 is stored for future use (e.g., for access or lookup by one or more downstream processes, systems, or services).

There are many different types and configurations of machine learning models. Illustrative, nonlimiting examples of some of the different types of machine learning models are shown in FIG. 9B and FIG. 9C, described below. The systems, models, and AI model services described herein are capable of including or using any of the various types of machine learning models, including but not limited to one or more of the types of models shown in FIG. 9B and FIG. 9C.

The examples shown in FIG. 9A and the accompanying description, above are provided for illustration purposes. This disclosure is not limited to the described examples.

FIG. 9B is a block diagram of a machine learning model portions of which are capable of being used by and/or included in a retrieval and ranking system in accordance with some examples of the present disclosure.

A specific example of a machine learning model is a deep neural network. Some machine learning models include multiple interconnected deep neural networks. In the example of FIG. 9B, a machine learning system 930 includes a deep neural network 934. The deep neural network 934 is configured via training and validation processes such as those described with reference to, e.g., FIG. 9A. Some examples of the deep neural network 934 are configured as a discriminative model and/or a generative model. In some examples, a deep neural network 934 performs both discriminative and generative tasks.

In computer science, deep learning refers to a class of machine learning that uses computer-implemented neural networks to generate predictive output, where the neural networks have one or more internal (or hidden) layers between and in addition to an input layer and an output layer. Each layer in a deep neural network (or deep learning model) performs a set of computational operations on the input to that layer.

Each layer of the neural network includes a set of nodes that each apply an activation function to one or more portions of the input to that layer to produce an output. The activation function performs a nonlinear transformation of the input and sends its output to the next layer of the network. For example, if the output of the activation function is equal to or exceeds a threshold value, the node passes its output to the next layer, but if the output is less than the threshold value, the output passed to the next layer is zero or a null value. The type of activation function used at a node or layer is selected based on the particular predictive task for which the model is configured and/or based on the model architecture. Examples of activation functions include the SoftMax function (for multi-class classification), the sigmoid function (for internal layers), and rectifier functions (e.g., ramp, or Rectified Linear Unit (ReLU)).

The input layer of a deep neural network receives and processes the model input, which includes raw data and/or pre-processed data such as aggregations, derivations, embeddings or vector representations of raw data. In some examples, the output of a layer of the neural network is connected to and used as the input to one or more other layers, such that each layer of the deep learning model creates a different (e.g., progressively more highly processed) set of information relating to the original, raw input (e.g., producing a different representation of the raw input at each layer). Weights are applied to the output of each node of each layer before the output is propagated to the next layer. The weight values are adjusted so that the outputs of some nodes or layers influences the final output more or less than the outputs of other nodes or layers, in some examples. The output layer of the neural network produces the final predictive output, which is made accessible to one or more downstream models, applications, systems, operations, processes or services.

Backpropagation is an example of a method that is often used to train a neural network model. In a feedforward step, the training data is propagated from the input layer through the internal layers to the final output by computing each successive layer's outputs up to and including the final output. A loss function (or cost function, such as cross-entropy, log loss, or squared error loss, or a logistic function) is used to compute error for the final output, for example, based on a comparison of the difference between the output predicted by the model and the expected or target output to the error computed on a previous iteration. The model weights (or parameters or coefficients) are adjusted to reduce the error, iteratively, until the error falls within an acceptable range or the error stops changing by more than a threshold amount (e.g., the model converges). In backpropagation, these iterative weight adjustments are propagated backward from the output layer through the internal layers. The gradient of the loss function or gradient descent (e.g., stochastic gradient descent) is often used in backpropagation.

In the example of FIG. 9B, the deep neural network 934 includes an input layer 935, one or more hidden layers 936, and an output layer 937. The input layer 935 receives one or more batches of model input 923 (e.g., input data sets X). In some examples, the input layer 935 includes a number of nodes that corresponds to the number of input features in a given input feature set X. The output of the input layer 935 becomes the input to the one or more hidden layers 936. The output of the one or more hidden layers 936 becomes the input to the output layer 937. The output layer 937 outputs the final predictive output 938. In some examples, each of the layers of the deep neural network 934 is fully connected in the sense that the output of each node of each layer is connected to the input of each node of the next subsequent layer. In other examples, the deep neural network 934 includes portions that are not fully connected.

The deep neural network 934 is capable of being configured and implemented as a service on a network. In some examples, the deep neural network 934 is configured using a machine learning library and an application programming interface (API), e.g., via an API call such as ML_library.model(p1, p2, . . . pn), where p indicates a parameter or argument of the call, such as a model hyperparameter or an input feature set identifier. Once configured, the deep neural network 934 and/or its output are hosted on one or more servers and/or data storage devices for accessibility to one or more requesting processes, systems, devices, frameworks, or services.

The input data set X includes numerical features, categorical features, quantitative values, qualitative values, raw features, compressed representations of raw features (e.g., vector representations or embeddings), natural language, and/or other forms of digital content. Embedding refers to a numerical representation of data, in some examples. An embedding encodes information, e.g., a set of features associated with an entity and/or item, relative to an embedding space. Embeddings and embedding spaces are generated by artificial intelligence (AI) models. An embedding is often expressed as a vector, where each dimension of the vector includes a numerical value that is an integer or a real number (e.g., a floating point value). The numerical value at a given dimension of the vector conveys information about the data represented by the embedding, relative to the embedding space, also referred to as a vector space. The embedding space includes all of the possible values of each dimension of the vector. The embedding space is defined by the way in which the AI model used to generate the vector has been trained and configured, including the training data used to train the AI model.

Embedding-based retrieval (EBR) is a method of searching for similar digital content, such as documents or portions of documents, using embeddings. Embedding-based retrieval involves converting digital data, e.g., sets of features, to embeddings and then using a similarity algorithm, such as nearest-neighbor search or cosine similarity, to identify embeddings that are similar to one another. Match or map refers to an exact match or an inexact match, in various examples. Match or map refers to a machine-determined predicted or estimated degree of relevance, similarity or compatibility between entities or data items that satisfies (e.g., meets or exceeds) a threshold level of relevance, similarity or compatibility, where the threshold level of relevance, similarity or compatibility is variable based on the requirements of a particular design or implementation. The threshold level of relevance, similarity, or compatibility is set lower or higher for different types of matching or mapping, in some examples.

In response to an instance of input data set X, deep neural network 934 computes and outputs a predictive output 938. The predictive output 938 is stored in a data storage for subsequent lookup or provided to one or more downstream systems, processes, devices, frameworks, and/or services.

The deep neural network 934 is configured and implemented as a network service, in some examples. The deep neural network 934 is configured using a machine learning library and an application programming interface (API), e.g., via an API call such as ML_library.model(p1, p2, . . . pn), where p indicates a parameter or argument of the call, such as a model hyperparameter or an input feature set identifier, in some examples. Once configured, the machine learning model 906 and/or its output are hosted on one or more servers and/or data storage devices for accessibility to one or more requesting processes, systems, devices, frameworks, or services.

The examples shown in FIG. 9B and the accompanying description, above are provided for illustration purposes. This disclosure is not limited to the described examples.

FIG. 9C is a block diagram of a machine learning model portions of which are capable of being used by and/or included in a retrieval and ranking system in some examples of the present disclosure.

A specific example of a deep neural network is a sequence to sequence model, which takes sequential data such as words, phrases, or images (sequences of characters, tokens, or pixel values) or time series data as input and outputs sequential data. An example of a sequence to sequence model is an encoder-decoder model. In an encoder-decoder model, a first neural network known as an encoder transforms the model input into an encoded version of the model input, e.g., an embedding or vector. In some examples, an encoder transforms a sentence or an image into a sequence of numbers. A second neural network known as the decoder takes the output of the encoder (e.g., the encoded version of the model input) and decodes it. In some examples, a decoder transforms the sequence of numbers created and output by the encoder into a translated sentence or another form of output.

A specific example of an encoder-decoder model is a transformer model. A transformer model is a deep neural network encoder-decoder model that uses a technique called attention or self-attention to detect relationships and dependencies among data elements in a sequence. Transformer models are capable of being used to perform various natural language processing (NLP) tasks and other machine learning tasks, such as generating content based on input attributes or tokens. In some examples, the attention mechanism facilitates the detection of relationships and dependencies between words and phrases.

Not all transformer models contain both an encoder and a decoder. Other forms of transformer models include a decoder-only architecture or an encoder-only architecture.

In the example of FIG. 9C, a machine learning system 940 includes a transformer model 942 with an encoder-decoder architecture. The transformer model 942 is constructed using a neural network-based machine learning model architecture. In some examples, the neural network-based architecture includes one or more self-attention layers (e.g., multi-head attention layer 945, masked multi-head attention layer 955, and multi-head attention layer 957) that allow the model to assign different weights to different features included in the model input.

Alternatively, or in addition, the neural network architecture includes feed-forward layers (e.g., feed-forward layer 947 and feed-forward layer 959) and residual connections (e.g., add & norm layer 946, add & norm layer 948, add & norm layer 956, add & norm layer 958, add & norm layer 960) that allow the model to machine-learn complex data patterns including relationships between different states, actions, and rewards in multiple different contexts. In some examples, transformer model 942 is constructed using a transformer-based architecture that includes self-attention layers, feed-forward layers, and residual connections between the layers. The exact number and arrangement of layers of each type as well as the hyperparameter values used to configure the model are determined based on the requirements of a particular design or implementation of the transformer system.

As shown in FIG. 9C, transformer model 942 feeds embedded subsequences 950 into encoder 944 and decoder 954. For example, transformer model 942 feeds inputs of embedded subsequences 950 into multi-head attention layer 945 of encoder 944. In some examples, inputs of embedded subsequences 950 are a series of tokens and the output of the encoder (e.g., encoder output representation 952), is a fixed-dimensional representation for each of the tokens of embedded subsequences 950 including an embedding for inputs of embedded subsequences 950. Transformer model 942 feeds encoder output representation 952 and outputs of embedded subsequences 950 into decoder 954 which generates a sequence of tokens based on encoder output representation 952 and the input embeddings. While a specific architecture of encoder 944 and decoder 954 is shown for simplicity, as explained above, the exact number and arrangement of layers of each type as well as the hyperparameter values used to configure the model are determined based on the requirements of a particular design or implementation. Therefore, in some examples, transformer model 942 includes different numbers, arrangements, and types of layers, such that each input token of embedded subsequences 950 is fed through the layers of transformer model 942 and is dependent on other input tokens of embedded subsequences 950.

Transformer model 942 illustrates a generic encoder/decoder model for simplicity. In such a model, encoder 944 encodes the input into a fixed-length vector (e.g., encoder output representation 952) and decoder 954 decodes the fixed-length vector into an output sequence. An encoder-only variation of transformer model 942 may include only encoder 944 and omit decoder 954. A decoder-only variation of transformer model 942 may include only decoder 954 and omit encoder 944.

In the encoder-decoder architecture of transformer model 942, encoder 944 and decoder 954 are trained together to maximize the conditional log-likelihood of the output given the input. Once trained, encoder 944 and decoder 954 are capable of generating output given an input sequence or scoring a pair of input-output sequences based on their probability of coexistence.

As shown in FIG. 9C, encoder 944 includes multi-head attention layer 945, add & norm layer 946, feed-forward layer 947, and add & norm layer 948. While not specifically shown in FIG. 9C, some variations of transformer model 942 include a position encoder at the input to encoder 944. The position encoder incorporates token position information into the input sequence by adding positional embeddings to the token embeddings. The positional information allows the encoder 944 to distinguish between tokens based on their positions in the input sequence.

Multi-head attention layer 945 receives inputs of embedded subsequences 950 and computes output representations for each of the input tokens of embedded subsequences 950 based on the inputs of embedded subsequences 950. For example, multi-head attention layer 945 converts each input token of embedded subsequences 950 into queries, keys, and values using query, key, and value matrices. Multi-head attention layer 945 computes the output representation of the input tokens of embedded subsequences 950 as the weighted sum of the values of all of the input tokens of embedded subsequences 950. Multi-head attention layer 945 computes the weights for the weighted sum by applying a compatibility function to the corresponding key and query for the value. For example, multi-head attention layer 945 uses a scaled dot product on the key and query of an input token to determine a weight to apply to a value of the input token. Multi-head attention layer 945 includes multiple attention blocks which each compute an output representation for the input token. Multi-head attention layer 945 aggregates the output representations of these attention blocks to generate a final output representation for multi-head attention layer 945.

Transformer model 942 feeds the output representation generated by multi-head attention layer 945 and residual connections from the inputs of embedded subsequences 950 into add & norm layer 946. By including these residual connections, transformer model 942 ensures that it does not “forget” features of embedded subsequences 950 during training. Forgetting in the context of machine learning refers to a phenomenon that occurs as the model continues to be sequentially trained on different datasets over time. Because the model continually adjusts the values of feature coefficients as it is trained on subsequent training datasets, these continuous adjustments of the feature coefficient values is capable of causing the influence of the datasets used earlier in training on those coefficient values to be lost or diluted.

Add & norm layer 946 sums the output representation generated by multi-head attention layer 945 and the residual connections from inputs of embedded subsequences 950 and applies a layer normalization to the result. In some examples, the add & normal layers also apply a SoftMax function to generate action probabilities for the inputs of embedded subsequences 950. For example, add & norm layer 946 generates estimated probabilities \hat{p}(aₖ|s), where aₖ is the action policy and s is the state features.

Transformer model 942 feeds the normalized output of add & norm layer 946 into feed-forward layer 947. Feed-forward layer 947 is a feed-forward network that receives the normalized output, feeds it through the hidden layers of feed-forward layer 947, and then feeds the output of feed-forward layer 947 into add & norm layer 948. Feed-forward layer 947 processes the information received from add & norm layer 946 and updates the hidden layers of feed-forward layer 947 based on the information (e.g., during training) and/or generate an output based on the hidden layers processing the information (e.g., during evaluation and/or inference). For example, during training, transformer model 942 updates the weights of the hidden layers of feed-forward layer 947 based on the inputs and the loss of the transformer system. Further details with regard to the loss of the transformer system as well as training objectives and metrics are discussed below. As an alternative example, during evaluation and/or inference, the weights of the hidden layers of feed-forward layer 947 are used to determine the output representation 952 of each of the input tokens of embedded subsequences 950.

Transformer model 942 feeds the output of feed-forward layer 947 into add & norm layer 948 as well as residual connections from the output of add & norm layer 946. Add & norm layer 948 sums the output of feed-forward layer 947 with the residual connections from add & norm layer 946 and applies a layer normalization to the result to generate encoder output representation 952. Transformer model 942 feeds encoder output representation 952 into multi-head attention layer 957 of decoder 954 as explained below.

While not specifically shown in FIG. 9C, some variations of transformer model 942 include a position encoder at the input to decoder 954. The position encoder incorporates token position information into the input sequence by adding positional embeddings to the token embeddings. The positional information allows the decoder 954 to distinguish between tokens based on their positions in the input sequence.

At decoder 954, masked multi-head attention layer 955 receives outputs of embedded subsequences 950 and computes representations for each of the output tokens of embedded subsequences 950 based on masked outputs of embedded subsequences 950. For example, masked multi-head attention layer 955 computes representations for each of the output tokens of embedded subsequences 950 based on previous output tokens while masking future output tokens. Masked multi-head attention layer 955 therefore only computes representations using tokens that come before the token masked multi-head attention layer 955 is trying to predict.

Transformer model 942 feeds the representation generated by masked multi-head attention layer 955 and residual connections from the outputs of embedded subsequences 950 into add & norm layer 956. Add & norm layer 956 sums the representation generated by masked multi-head attention layer 955 and the residual connections from outputs of embedded subsequences 950 and applies a layer normalization to the result.

Transformer model 942 feeds the normalized output of add & norm layer 956 into multi-head attention layer 957. Multi-head attention layer 957 receives the normalized output of add & norm layer 956 as well as encoder output representation 952 from encoder 944 and generates a representation based on both of these inputs.

Transformer model 942 feeds the representation generated by multi-head attention layer 957 and residual connections from the output of add & norm layer 956 into add & norm layer 958. Add & norm layer 958 sums the representation generated by multi-head attention layer 957 and the residual connections from the output of add & norm layer 956 and applies a layer normalization to the result.

Transformer model 942 feeds the normalized output of add & norm layer 958 into feed-forward layer 959. Feed-forward layer 959 is a feed-forward network that receives the normalized output, feeds it through the hidden layers of feed-forward layer 959, and then feeds the output of feed-forward layer 959 into add & norm layer 969. Feed-forward layer 959 processes the information received from add & norm layer 958 and updates the hidden layers of feed-forward layer 959 based on the information (e.g., during training) and/or generate an output based on the hidden layers processing the information (e.g., during evaluation and/or inference). For example, during training, transformer model 942 updates the weights of the hidden layers of feed-forward layer 959 based on the inputs and the loss of the transformer system. Further details with regard to the loss of the transformer system as well as training objectives and metrics are discussed below. As an alternative example, during evaluation and/or inference, the weights of the hidden layers of feed-forward layer 959 are used to determine the output of feed-forward layer 959.

Transformer model 942 feeds the output of feed-forward layer 959 into add & norm layer 960 as well as residual connections from the output of add & norm layer 958. Add & norm layer 960 sums the output of feed-forward layer 959 with the residual connections from add & norm layer 958 and applies a layer normalization to the result to generate an output.

Transformer model 942 generates output probabilities 962 from the output of add & norm layer 960. For example, transformer model 942 applies a linear transformation and a SoftMax function to the output of add & norm layer 960 to generate a normalized vector of output probabilities 962.

In some examples, such as during training, transformer model 942 determines a loss for the system based on output probabilities 962. In some examples, transformer model 942 uses deep quantile regression for training. In such an example, output probabilities 962 includes a mean prediction probability and estimations for the upper and lower bounds of the range of prediction such that output probabilities 926 includes an uncertainty range. In one example, the loss function of transformer model 942 using deep quantile regression is represented by the following equation:

$$L ( {ξ}_{i} \vert α ) = \{ \begin{matrix}{αξ}_{i} if {ξ}_{i} \geq 0 , \\ ( α - 1 ) {ξ}_{i} if {ξ}_{i} < 0\end{matrix} ,$$

where α is the required quantile (a value between 0 and 1 representing the desired quantile) and ξᵢ=yᵢ−ƒ(xᵢ), where ƒ(xᵢ) is the mean predicted by output probabilities 962, yᵢ are the outputs of embedded subsequences 950 and xᵢ are the inputs of embedded subsequences 950. The loss over the entirety of a dataset of embedded subsequences 950 where embedded subsequences 950 has a length of N is capable of being represented by the following equation:

$$ℒ ( y , f \vert α ) = \frac{1}{N} {\sum }_{i = 1}^{N} ℒ ( {y}_{i} - f ( {x}_{i} ) \vert α ) .$$

In such examples, output probabilities 962 includes three values: a mean prediction, a lower bound quantile, and an upper bound quantile. In some examples, transformer model 942 uses upper confidence bound or Thompson sampling. In some examples, transformer model 942 determines model output 964 based on the mean prediction, the lower bound quantile, and the upper bound quantile based on upper confidence bound and/or Thompson sampling.

In some examples, transformer model 942 is trained to optimize the model parameters with trajectory-specific normalizations using cross-entropy loss. For example, transformer model 942 uses a loss function represented by the following equation:

$$L ( θ ) = \frac{1}{{N}_{traj}} {\sum }_{i}^{{N}_{traj}} {\sum }_{t = 1}^{{T}_{i}} {w}_{i} {\sum }_{k} log ( \hat{p} ( {a}_{k}^{( it )} \vert {s}^{( it )} ) ) ,$$

where Nₜᵣₐⱼ is the trajectory count, wᵢ is the normalization weight, aₖ^{(it)} is the predicted action for the trajectory i at timestep t, and s^{(it)} is the state of an online system for the trajectory i at timestep t. In some examples, transformer model 942 uses trajectory-wise normalization. In some examples, the add & norm layers of transformer model 942 normalize the weights according to the following equation:

$${w}_{i} = \frac{1}{{T}_{i}} ,$$

where Tᵢ is the length of trajectory i. In some examples, transformer model 942 uses global normalization. In some examples, the add & norm layers of transformer model 942 normalize the weights according to the following equation: wᵢ=c, where c is a positive scalar. In some examples, the scalar c is predetermined.

Language models, including large language models, are sometimes implemented using transformer models. A language model is commonly constructed using a neural network-based machine learning model architecture. The language model is capable of being constructed using a transformer-based architecture that includes self-attention layers, feed-forward layers, and residual connections between the layers. The exact number and arrangement of layers of each type as well as the hyperparameter values used to configure the model are determined based on the requirements of a particular design or implementation. The self-attention layers allow the model to assign different weights to different portions of the model input (e.g., different words or phrases included in the model input). The feed-forward layers and residual connections allow the model to machine-learn complex data patterns including relationships between different words or phrases in multiple different contexts.

In some examples, the neural network-based machine learning model architecture of a language model includes or is based on one or more generative transformer models, one or more generative pre-trained transformer (GPT) models, one or more bidirectional encoder representations from transformers (BERT) models, one or more large language models (LLMs), one or more XLNet models, and/or Recurrent Neural Networks (RNNs). In some examples, a neural network-based machine learning model architecture includes is capable of outputting different modalities (e.g., text, image, sound, etc.) separately and/or in combination based on digital content input. Accordingly, in some examples, a multimodal neural network is capable of outputting digital content that includes a combination of two or more of text, images, video or sound.

The transformer model 942 is configured and implemented as a network service, in some examples. The transformer model 942 is configured using a machine learning library and an application programming interface (API), e.g., via an API call such as ML_library.model(p1, p2, . . . pn), where p indicates a parameter or argument of the call, such as a model hyperparameter or an input identifier. Once configured, the transformer model 942 and/or its output are hosted on one or more servers and/or data storage devices for accessibility to one or more requesting processes, systems, devices, frameworks, or services.

The examples shown in FIG. 9C and the accompanying description, above are provided for illustration purposes. This disclosure is not limited to the described examples.

The methods described herein are performed by processing logic that includes hardware (e.g., processing device, circuitry, dedicated logic, programmable logic, microcode, hardware of a device, integrated circuit, etc.), software (e.g., instructions run or executed on a processing device), or a combination thereof. The methods are performed by one or more computing system components shown in their respective figures and/or components shown in other figures. Although shown in a particular sequence or order, unless otherwise specified, the order of the processes performed in any method is modifiable. In some examples, the processes are performed in a different order and/or some processes are performed in parallel. Additionally, one or more processes are omitted in some examples of some of the methods. Thus, not all processes are required in every example or every method. Other process flows are possible.

FIG. 10 is a block diagram of an example computer system including components of a retrieval and ranking system in accordance with some examples of the present disclosure.

In FIG. 10, an example machine of a computer system 1000 is shown, within which a set of instructions for causing the machine to perform any of the methodologies discussed herein are capable of being executed. In some examples, the computer system 1000 corresponds to a component of a networked computer system (e.g., any one or more of the components shown in FIG. 1, FIG. 2, FIG. 3A, FIG. 3B, FIG. 4, FIG. 5, FIG. 6, FIG. 7, FIG. 8, FIG. 9A, FIG. 9B, and/or FIG. 9C) that includes, is coupled to, or utilizes a machine to execute an operating system to perform operations corresponding to any one or more components shown in FIG. 1, FIG. 2, FIG. 3A, FIG. 3B, FIG. 4, FIG. 5, FIG. 6, FIG. 7, FIG. 8, FIG. 9A, FIG. 9B, and/or FIG. 9C. For example, computer system 1000 corresponds to a portion of a computing system when the computing system is executing a portion of any one or more components shown in FIG. 1, FIG. 2, FIG. 3A, FIG. 3B, FIG. 4, FIG. 5, FIG. 6, FIG. 7, FIG. 8, FIG. 9A, FIG. 9B, and/or FIG. 9C.

The machine is connected (e.g., networked) to other machines in a network, such as a local area network (LAN), an intranet, an extranet, and/or the Internet. The machine operates in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM) or Rambus DRAM (RDRAM), etc.), a memory 1003 (e.g., flash memory, static random access memory (SRAM), etc.), an input/output system 1010, and a data storage system 1040, which communicate with each other via a bus 1030.

Processing device 1002 represents one or more general-purpose processing devices such as a microprocessor, a central processing unit, or the like. In some examples, the processing device is a complex instruction set computing (CISC) microprocessor, reduced instruction set computing (RISC) microprocessor, very long instruction word (VLIW) microprocessor, or a processor implementing other instruction sets, or processors implementing a combination of instruction sets. In some examples, processing device 1002 includes a special-purpose processing device such as an application specific integrated circuit (ASIC), a field programmable gate array (FPGA), a digital signal processor (DSP), network processor, or the like. The processing device 1002 is to execute instructions 1012 for performing the operations and steps discussed herein.

In some examples of FIG. 10, retrieval and ranking system 1050 represents portions of a retrieval and ranking system described herein while the computer system 1000 is executing those portions of the retrieval and ranking system. Instructions 1012 include portions of retrieval and ranking system 1050 when those portions of the retrieval and ranking system 1050 are being executed by processing device 1002. Thus, the retrieval and ranking system 1050 is shown in dashed lines as part of instructions 1012 to illustrate that, at times, portions of the retrieval and ranking system 1050 are executed by processing device 1002. For example, when at least some portion of the retrieval and ranking system 1050 is embodied in instructions to cause processing device 1002 to perform the method(s) described herein, some of those instructions are read into processing device 1002 (e.g., into an internal cache or other memory) from main memory 1004 and/or data storage system 1040. In some examples, it is not required that all of the retrieval and ranking system 1050 be included in instructions 1012 at the same time and portions of the retrieval and ranking system 1050 are stored in another component of computer system 1000 at other times, e.g., when a portion of the retrieval and ranking system 1050 is not being executed by processing device 1002.

The computer system 1000 further includes a network interface device 1008 to communicate over the network 1020. Network interface device 1008 provides a two-way data communication coupling to a network. In some examples, network interface device 1008 includes an integrated-services digital network (ISDN) card, cable modem, satellite modem, or a modem to provide a data communication connection to a corresponding type of telephone line. In some examples, network interface device 1008 includes a local area network (LAN) card to provide a data communication connection to a compatible LAN. Wireless links are included, in some examples. Network interface device 1008 sends and receives electrical, electromagnetic, or optical signals that carry digital data representing various types of information.

The network link is capable of providing data communication through one or more networks to other data devices. In some examples, a network link provides a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 1000.

Computer system 1000 is capable of sending messages and receiving data, including program code, through the network(s) and network interface device 1008. In some examples, a server is capable of transmitting a requested code for an application program through the Internet and network interface device 1008. The received code is executed by processing device 1002 as it is received, and/or stored in data storage system 1040 or other non-volatile storage for later execution.

The input/output system 1010 includes an output device, such as a display, for example a liquid crystal display (LCD) or a touchscreen display, for displaying information to a computer user, or a speaker, a haptic device, or another form of output device. The input/output system 1010 includes an input device, for example, alphanumeric keys and other keys configured for communicating information and command selections to processing device 1002. An input device sometimes includes a cursor control, such as a mouse, a trackball, or cursor direction keys for communicating direction information and command selections to processing device 1002 and for controlling cursor movement on a display. An input device sometimes includes a microphone, a sensor, or an array of sensors, for communicating sensed information to processing device 1002. Examples of sensed information include voice commands, audio signals, geographic location information, haptic information, and/or digital imagery, for example.

The data storage system 1040 includes a machine-readable storage medium 1042 (also known as a computer-readable medium) on which is stored instructions 1044 or software embodying any of the methodologies or functions described herein. The instructions 1044 sometimes reside, completely or at least partially, within the main memory 1004 and/or within the processing device 1002 during execution thereof by the computer system 1000, the main memory 1004 and the processing device 1002 also constituting machine-readable storage media. In one example, the instructions 1044 include instructions to implement functionality corresponding to a retrieval and ranking system (e.g., any one or more of the components shown in any one or more components shown in FIG. 1, FIG. 2, FIG. 3A, FIG. 3B, FIG. 4, FIG. 5, FIG. 6, FIG. 7, FIG. 8, FIG. 9A, FIG. 9B, and/or FIG. 9C).

Dashed lines are used in FIG. 10 to indicate that it is not required that the retrieval and ranking system be embodied entirely in instructions 1012, 1014, and 1044 at the same time. In one example, portions of the retrieval and ranking system are embodied in instructions 1014, which are read into main memory 1004 as instructions 1014, and portions of instructions 1012 are read into processing device 1002 as instructions 1012 for execution. In another example, some portions of the retrieval and ranking system are embodied in instructions 1044 while other portions are embodied in instructions 1014 and still other portions are embodied in instructions 1012.

While the machine-readable storage medium 1042 is shown in an example to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media.

The examples shown in FIG. 10 and the accompanying description, above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure refers to actions and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations described herein. This apparatus is specially constructed for the intended purposes, in some examples. In other examples, the apparatus includes a general-purpose computer selectively activated or reconfigured by a computer program stored in the computer. In some examples, a computer system or other data processing system including any one or more of the components shown in FIG. 1, FIG. 2, FIG. 3A, FIG. 3B, FIG. 4, FIG. 5, FIG. 6, FIG. 7, FIG. 8, FIG. 9A, FIG. 9B, and/or FIG. 9C, carries out the above-described computer-implemented methods in response to its processor executing a computer program (e.g., a sequence of instructions) contained in a memory or other non-transitory machine-readable storage medium. Such a computer program is be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems are capable of being used. A more specialized apparatus is constructed, in some examples. Examples of structure for these systems are provided in the description. Aspects of this disclosure are not limited to any particular programming language. A variety of programming languages are usable to implement the various aspects of this disclosure.

Some examples of the present disclosure are provided as a computer program product, or software, which includes a machine-readable medium having stored thereon instructions, which is used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in artificial intelligence (AI) features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform. According to the techniques described herein, personal data may be removed from any training dataset that is used to train AI models.

The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

Illustrative examples of the technologies disclosed herein are provided below. An example of the technologies includes any of the examples described herein, or any combination of any of the examples described herein, or any combination of any portions of the examples described herein.

In some aspects, the techniques described herein relate to a method including: at a first device, inputting an entity embedding for an entity and an item embedding for each item of a plurality of items to a scoring function of a retrieval model, wherein the entity embedding and the item embedding are pre-computed at a second device using a first language model of the retrieval model, at the first device, using the scoring function of the retrieval model, generating a retrieval score for the entity and a first item of the plurality of items; using the retrieval score to identify an item subset of the plurality of items, wherein the first item is excluded from the item subset; inputting a ranking prompt to a ranking model including a second language model, wherein the second language model and the first language model have a common parameter value; and by the second language model, generating a ranking score for the entity and a second item in response to the ranking prompt, wherein the second item is included in the plurality of items and the item subset, and wherein an online system uses the ranking score to include or exclude the second item from a presentation of digital content to the entity via a device.

In some aspects, the techniques described herein relate to a method, further including: including, in the ranking prompt, a combination of an entity prompt and an item prompt, wherein the entity prompt includes a ranking instruction and entity interaction data for the entity, and the item prompt includes item interaction data for each item of the item subset.

In some aspects, the techniques described herein relate to a method, wherein the ranking instruction instructs the second language model to generate and output a likelihood of engagement of the entity with the each item of the item subset using the entity interaction data and the item interaction data.

In some aspects, the techniques described herein relate to a method, wherein the entity embedding is pre-computed by inputting the entity prompt into an entity-side encoder of the first language model and the item embedding is pre-computed by inputting the item prompt into an item-side encoder of the first language model.

In some aspects, the techniques described herein relate to a method, wherein the first language model of the retrieval model includes a dual encoder including a decoder-only language model, and the method includes using the dual encoder including the decoder-only language model to generate the retrieval score.

In some aspects, the techniques described herein relate to a method, wherein the second language model of the ranking model includes a cross encoder including the decoder-only language model, and the method includes using the cross encoder including the decoder-only language model to generate the ranking score.

In some aspects, the techniques described herein relate to a method, wherein the first device includes a graphics processing unit (GPU) and the method further includes: concatenating item caches at the GPU and storing the concatenated item caches at the GPU using a block attention mechanism.

In some aspects, the techniques described herein relate to a method, further including: at the first device, computing the retrieval score using the entity embedding and an index of item embeddings for the plurality of items.

In some aspects, the techniques described herein relate to a method, wherein the first device includes a graphics processing unit (GPU), the second device is different from the first device, and the method includes generating the ranking score at the second device.

In some aspects, the techniques described herein relate to a method, further including: using a matrix superimposition mechanism to superimpose items of the item subset to produce a superimposed item subset; and concurrently generating ranking scores for the items using the superimposed item subset.

In some aspects, the techniques described herein relate to a method, further including: concurrently sending a first call to the retrieval model and a second call to the ranking model, wherein the retrieval model identifies the item subset in response to the first call and the ranking model stores an entity prompt in a cache in response to the second call.

In some aspects, the techniques described herein relate to a method, further including: joining the item subset identified by the retrieval model with the entity prompt stored in the cache; and using the cache to formulate the ranking prompt.

In some aspects, the techniques described herein relate to a system including: a processor; and memory coupled to the processor, wherein the memory includes instructions that when executed by the processor cause the processor to: at a first device, input an entity embedding for an entity and an item embedding for each item of a plurality of items to a scoring function of a retrieval model, wherein the entity embedding and the item embedding are pre-computed at a second device using a first language model of the retrieval model, at the first device, using the scoring function of the retrieval model, compute a retrieval score for the entity and a first item of the plurality of items; use the retrieval score to identify an item subset of the plurality of items, wherein the first item is excluded from the item subset; input a ranking prompt to a ranking model including a second language model, wherein the second language model and the first language model have a common parameter value; and by the second language model, generate a ranking score for the entity and a second item in response to the ranking prompt, wherein the second item is included in the plurality of items and the item subset, and wherein an online system uses the ranking score to include or exclude the second item from a presentation of digital content to the entity via a device.

In some aspects, the techniques described herein relate to a system, wherein the first language model of the retrieval model includes a dual encoder including a decoder-only language model, the second language model of the ranking model includes a cross encoder including the decoder-only language model, and the instructions further cause the processor to: use the dual encoder including the decoder-only language model to generate the retrieval score; and use the cross encoder including the decoder-only language model to generate the ranking score.

In some aspects, the techniques described herein relate to a system, wherein the first device includes a graphics processing unit (GPU) and the instructions further cause the processor to: concatenate item caches for items in the item subset at the GPU; and store the concatenated item caches at the GPU using a block attention mechanism.

In some aspects, the techniques described herein relate to a system, wherein the first device includes a graphics processing unit (GPU), the second device is different from the first device, and the instructions further cause the processor to generate the ranking score at the second device.

In some aspects, the techniques described herein relate to a system, wherein the instructions further cause the processor to: use a matrix superimposition mechanism to superimpose items of the item subset to produce a superimposed item subset; and concurrently generate ranking scores for the items using the superimposed item subset.

In some aspects, the techniques described herein relate to a system, wherein the instructions further cause the processor to: concurrently send a first call to the retrieval model and send a second call to the ranking model, wherein the retrieval model identifies the item subset in response to the first call and the ranking model stores an entity prompt in a cache in response to the second call; join the item subset identified by the retrieval model with the entity prompt stored in the cache; and use the cache to formulate the ranking prompt.

In some aspects, the techniques described herein relate to a non-transitory computer-readable medium including instructions that when executed by a processor cause the processor to: at a first device, input an entity embedding for an entity and an item embedding for each item of a plurality of items to a scoring function of a retrieval model, wherein the entity embedding and the item embedding are pre-computed at a second device using a first language model of the retrieval model, at the first device, using the scoring function of the retrieval model, compute a retrieval score for the entity and a first item of the plurality of items; use the retrieval score to identify an item subset of the plurality of items, wherein the first item is excluded from the item subset; input a ranking prompt to a ranking model including a second language model, wherein the second language model and the first language model have a common parameter value; and by the second language model, generate a ranking score for the entity and a second item in response to the ranking prompt, wherein the second item is included in the plurality of items and the item subset, and wherein an online system uses the ranking score to include or exclude the second item from a presentation of digital content to the entity via a device.

In some aspects, the techniques described herein relate to a non-transitory computer-readable medium, wherein the first language model of the retrieval model includes a dual encoder including a decoder-only language model, the second language model of the ranking model includes a cross encoder including the decoder-only language model, and the instructions further cause the processor to: use the dual encoder including the decoder-only language model to generate the retrieval score at the first device; and use the cross encoder including the decoder-only language model to generate the ranking score at the second device.
Clause 1. A method comprising: at a first device, inputting an entity embedding for an entity and an item embedding for each item of a plurality of items to a scoring function of a retrieval model, wherein the entity embedding and the item embedding are pre-computed at a second device using a first language model of the retrieval model, at the first device, using the scoring function of the retrieval model, generating a retrieval score for the entity and a first item of the plurality of items; using the retrieval score to identify an item subset of the plurality of items, wherein the first item is excluded from the item subset; inputting a ranking prompt to a ranking model comprising a second language model, wherein the second language model and the first language model have a common parameter value; and by the second language model, generating a ranking score for the entity and a second item in response to the ranking prompt, wherein the second item is included in the plurality of items and the item subset, and wherein an online system uses the ranking score to include or exclude the second item from a presentation of digital content to the entity via a device.
Clause 2. The method of clause 1, further comprising: including, in the ranking prompt, a combination of an entity prompt and an item prompt, wherein the entity prompt comprises a ranking instruction and entity interaction data for the entity, and the item prompt comprises item interaction data for each item of the item subset.
Clause 3. The method of clause 1 or clause 2, wherein the ranking instruction instructs the second language model to generate and output a likelihood of engagement of the entity with the each item of the item subset using the entity interaction data and the item interaction data.
Clause 4. The method of clause 1, clause 2, or clause 3, wherein the entity embedding is pre-computed by inputting the entity prompt into an entity-side encoder of the first language model and the item embedding is pre-computed by inputting the item prompt into an item-side encoder of the first language model.
Clause 5. The method of any of clauses 1-4, wherein the first language model of the retrieval model comprises a dual encoder comprising a decoder-only language model, and the method comprises using the dual encoder comprising the decoder-only language model to generate the retrieval score.
Clause 6. The method of any of clauses 1-5, wherein the second language model of the ranking model comprises a cross encoder comprising the decoder-only language model, and the method comprises using the cross encoder comprising the decoder-only language model to generate the ranking score.
Clause 7. The method of any of clauses 1-6, wherein the first device comprises a graphics processing unit (GPU) and the method further comprises: concatenating item caches at the GPU and storing the concatenated item caches at the GPU using a block attention mechanism.
Clause 8. The method of any of clauses 1-7, further comprising: at the first device, computing the retrieval score using the entity embedding and an index of item embeddings for the plurality of items.
Clause 9. The method of any of clauses 1-8, wherein the first device comprises a graphics processing unit (GPU), the second device is different from the first device, and the method comprises generating the ranking score at the second device.
Clause 10. The method of any of clauses 1-9, further comprising: using a matrix superimposition mechanism to superimpose items of the item subset to produce a superimposed item subset; and concurrently generating ranking scores for the items using the superimposed item subset.
Clause 11. The method of any of clauses 1-10, further comprising: concurrently sending a first call to the retrieval model and a second call to the ranking model, wherein the retrieval model identifies the item subset in response to the first call and the ranking model stores an entity prompt in a cache in response to the second call.
Clause 12. The method of any of clauses 1-11, further comprising: joining the item subset identified by the retrieval model with the entity prompt stored in the cache; and using the cache to formulate the ranking prompt.
Clause 13. A system comprising: a processor; and memory coupled to the processor, wherein the memory comprises instructions that when executed by the processor cause the processor to: at a first device, input an entity embedding for an entity and an item embedding for each item of a plurality of items to a scoring function of a retrieval model, wherein the entity embedding and the item embedding are pre-computed at a second device using a first language model of the retrieval model, at the first device, using the scoring function of the retrieval model, compute a retrieval score for the entity and a first item of the plurality of items; use the retrieval score to identify an item subset of the plurality of items, wherein the first item is excluded from the item subset; input a ranking prompt to a ranking model comprising a second language model, wherein the second language model and the first language model have a common parameter value; and by the second language model, generate a ranking score for the entity and a second item in response to the ranking prompt, wherein the second item is included in the plurality of items and the item subset, and wherein an online system uses the ranking score to include or exclude the second item from a presentation of digital content to the entity via a device.
Clause 14. The system of clause 13, wherein the first language model of the retrieval model comprises a dual encoder comprising a decoder-only language model, the second language model of the ranking model comprises a cross encoder comprising the decoder-only language model, and the instructions further cause the processor to: use the dual encoder comprising the decoder-only language model to generate the retrieval score; and use the cross encoder comprising the decoder-only language model to generate the ranking score.
Clause 15. The system of clause 13 or clause 14, wherein the first device comprises a graphics processing unit (GPU) and the instructions further cause the processor to: concatenate item caches for items in the item subset at the GPU; and store the concatenated item caches at the GPU using a block attention mechanism.
Clause 16. The system of any of clauses 13-15, wherein the first device comprises a graphics processing unit (GPU), the second device is different from the first device, and the instructions further cause the processor to generate the ranking score at the second device.
Clause 17. The system of any of clauses 13-16, wherein the instructions further cause the processor to: use a matrix superimposition mechanism to superimpose items of the item subset to produce a superimposed item subset; and concurrently generate ranking scores for the items using the superimposed item subset.
Clause 18. The system of any of clauses 13-17, wherein the instructions further cause the processor to: concurrently send a first call to the retrieval model and send a second call to the ranking model, wherein the retrieval model identifies the item subset in response to the first call and the ranking model stores an entity prompt in a cache in response to the second call; join the item subset identified by the retrieval model with the entity prompt stored in the cache; and use the cache to formulate the ranking prompt.
Clause 19. A non-transitory computer-readable medium comprising instructions that when executed by a processor cause the processor to: at a first device, input an entity embedding for an entity and an item embedding for each item of a plurality of items to a scoring function of a retrieval model, wherein the entity embedding and the item embedding are pre-computed at a second device using a first language model of the retrieval model, at the first device, using the scoring function of the retrieval model, compute a retrieval score for the entity and a first item of the plurality of items; use the retrieval score to identify an item subset of the plurality of items, wherein the first item is excluded from the item subset; input a ranking prompt to a ranking model comprising a second language model, wherein the second language model and the first language model have a common parameter value; and by the second language model, generate a ranking score for the entity and a second item in response to the ranking prompt, wherein the second item is included in the plurality of items and the item subset, and wherein an online system uses the ranking score to include or exclude the second item from a presentation of digital content to the entity via a device.
Clause 20. The non-transitory computer-readable medium of clause 19, wherein the first language model of the retrieval model comprises a dual encoder comprising a decoder-only language model, the second language model of the ranking model comprises a cross encoder comprising the decoder-only language model, and the instructions further cause the processor to: use the dual encoder comprising the decoder-only language model to generate the retrieval score at the first device; and use the cross encoder comprising the decoder-only language model to generate the ranking score at the second device.

Aspects of the disclosure have been described with reference to specific examples thereof. Various modifications are capable of being made to the described examples without departing from the spirit and scope of the disclosure reflected in the claims. The specification and drawings are illustrative and not restrictive.

What is claimed is:

1. A method comprising:
at a first device, inputting an entity embedding for an entity and an item embedding for each item of a plurality of items to a scoring function of a retrieval model, wherein the entity embedding and the item embedding are pre-computed at a second device using a first language model of the retrieval model,
at the first device, using the scoring function of the retrieval model, generating a retrieval score for the entity and a first item of the plurality of items;
using the retrieval score to identify an item subset of the plurality of items;
inputting a ranking prompt to a ranking model comprising a second language model, wherein the second language model and the first language model have a common parameter value; and
by the second language model, generating a ranking score for the entity and a second item in response to the ranking prompt, wherein the second item is included in the plurality of items and the item subset, and wherein an online system uses the ranking score to include or exclude the second item from a presentation of digital content to the entity via a device.

2. The method of claim 1, further comprising:
including, in the ranking prompt, a combination of an entity prompt and an item prompt, wherein the entity prompt comprises a ranking instruction and entity interaction data for the entity, and the item prompt comprises item interaction data for each item of the item subset.

3. The method of claim 2, wherein the ranking instruction instructs the second language model to generate and output a likelihood of engagement of the entity with the each item of the item subset using the entity interaction data and the item interaction data.

4. The method of claim 2, wherein the entity embedding is pre-computed by inputting the entity prompt into an entity-side encoder of the first language model and the item embedding is pre-computed by inputting the item prompt into an item-side encoder of the first language model.

5. The method of claim 1, wherein the first language model of the retrieval model comprises a dual encoder comprising a decoder-only language model, and the method comprises using the dual encoder comprising the decoder-only language model to generate the retrieval score.

6. The method of claim 5, wherein the second language model of the ranking model comprises a cross encoder comprising the decoder-only language model, and the method comprises using the cross encoder comprising the decoder-only language model to generate the ranking score.

7. The method of claim 5, wherein the first device comprises a graphics processing unit (GPU) and the method further comprises:
concatenating item caches at the GPU and storing the concatenated item caches at the GPU using a block attention mechanism.

8. The method of claim 1, further comprising:
at the first device, computing the retrieval score using the entity embedding and an index of item embeddings for the plurality of items.

9. The method of claim 1, wherein the first device comprises a graphics processing unit (GPU), the second device is different from the first device, and the method comprises generating the ranking score at the second device.

10. The method of claim 1, further comprising:
using a matrix superimposition mechanism to superimpose items of the item subset to produce a superimposed item subset; and
concurrently generating ranking scores for the items using the superimposed item subset.

11. The method of claim 1, further comprising:
concurrently sending a first call to the retrieval model and a second call to the ranking model, wherein the retrieval model identifies the item subset in response to the first call and the ranking model stores an entity prompt in a cache in response to the second call.

12. The method of claim 11, further comprising:
joining the item subset identified by the retrieval model with the entity prompt stored in the cache; and
using the cache to formulate the ranking prompt.

13. A system comprising:
a processor; and
memory coupled to the processor, wherein the memory comprises instructions that when executed by the processor cause the processor to:
at a first device, input an entity embedding for an entity and an item embedding for each item of a plurality of items to a scoring function of a retrieval model, wherein the entity embedding and the item embedding are pre-computed at a second device using a first language model of the retrieval model,
at the first device, using the scoring function of the retrieval model, compute a retrieval score for the entity and a first item of the plurality of items;
use the retrieval score to identify an item subset of the plurality of items, wherein the first item is excluded from the item subset;
input a ranking prompt to a ranking model comprising a second language model, wherein the second language model and the first language model have a common parameter value; and
by the second language model, generate a ranking score for the entity and a second item in response to the ranking prompt, wherein the second item is included in the plurality of items and the item subset, and wherein an online system uses the ranking score to include or exclude the second item from a presentation of digital content to the entity via a device.

14. The system of claim 13, wherein the first language model of the retrieval model comprises a dual encoder comprising a decoder-only language model, the second language model of the ranking model comprises a cross encoder comprising the decoder-only language model, and the instructions further cause the processor to:
use the dual encoder comprising the decoder-only language model to generate the retrieval score; and
use the cross encoder comprising the decoder-only language model to generate the ranking score.

15. The system of claim 13, wherein the first device comprises a graphics processing unit (GPU) and the instructions further cause the processor to:
concatenate item caches for items in the item subset at the GPU; and
store the concatenated item caches at the GPU using a block attention mechanism.

16. The system of claim 13, wherein the first device comprises a graphics processing unit (GPU), the second device is different from the first device, and the instructions further cause the processor to generate the ranking score at the second device.

17. The system of claim 13, wherein the instructions further cause the processor to:
use a matrix superimposition mechanism to superimpose items of the item subset to produce a superimposed item subset; and
concurrently generate ranking scores for the items using the superimposed item subset.

18. The system of claim 13, wherein the instructions further cause the processor to:
concurrently send a first call to the retrieval model and send a second call to the ranking model, wherein the retrieval model identifies the item subset in response to the first call and the ranking model stores an entity prompt in a cache in response to the second call;
join the item subset identified by the retrieval model with the entity prompt stored in the cache; and
use the cache to formulate the ranking prompt.

19. A non-transitory computer-readable medium comprising instructions that when executed by a processor cause the processor to:
at a first device, input an entity embedding for an entity and an item embedding for each item of a plurality of items to a scoring function of a retrieval model, wherein the entity embedding and the item embedding are pre-computed at a second device using a first language model of the retrieval model,
at the first device, using the scoring function of the retrieval model, compute a retrieval score for the entity and a first item of the plurality of items;
use the retrieval score to identify an item subset of the plurality of items, wherein the first item is excluded from the item subset;
input a ranking prompt to a ranking model comprising a second language model, wherein the second language model and the first language model have a common parameter value; and
by the second language model, generate a ranking score for the entity and a second item in response to the ranking prompt, wherein the second item is included in the plurality of items and the item subset, and wherein an online system uses the ranking score to include or exclude the second item from a presentation of digital content to the entity via a device.

20. The non-transitory computer-readable medium of claim 19, wherein the first language model of the retrieval model comprises a dual encoder comprising a decoder-only language model, the second language model of the ranking model comprises a cross encoder comprising the decoder-only language model, and the instructions further cause the processor to:
use the dual encoder comprising the decoder-only language model to generate the retrieval score at the first device; and
use the cross encoder comprising the decoder-only language model to generate the ranking score at the second device.
